(19) United States
(12) Patent Application Publication
(10) Pub. No.: US 2024/0195687 A1
(43) Pub. Date: Jun. 13, 2024

(54) DYNAMIC ASSESSMENT OF NETWORK PERFORMANCE AND SELECTIVE REMEDIATION RECOMMENDATIONS

(71) Applicant: ARRIS Enterprises LLC, Suwanee, GA (US)

(72) Inventors: Chandan Shrestha, Bangalore (IN); Shailesh Gupta, Bangalore (IN); Rajiv Ramnath Iyer, Los Altos, CA (US); See Ho Ting, Singapore (SG); Hemant Bhatnagar, Cupertino, CA (US); Ravi Kiran Mattparti, Cupertino, CA (US); Virendra Malaviya, Cupertino, CA (US)

(73) Assignee: ARRIS Enterprises LLC, Suwanee, GA (US)

(21) Appl. No.: 18/556,137

(22) PCT Filed: Apr. 7, 2022
(86) PCT No.: PCT/US2022/023769

§ 371 Date: Oct. 19, 2023

Related U.S. Application Data
(60) Provisional application No. 63/311,595, filed on Feb. 18, 2022.

(30) Foreign Application Priority Data
Apr. 19, 2021 (IN) 202121017953
Oct. 30, 2021 (IN) 202121049842

(51) Int. Cl. H04L 41/0816

(52) U.S. Cl. CPC H04L 41/0816

(57) ABSTRACT

A computer system is described. During operation, the computer system may receive information specifying communication in a network. Then, the computer system may detect a network problem based at least in part on the information. Moreover, the computer system may automatically determine a remedial action based at least in part on the detected network problem and may automatically perform the determined remedial action. Alternatively, when the remedial action cannot be determined, the computer system may selectively collect additional information for a predefined time interval, e.g., using one or more edge electronic devices or one or more controllers in the network. Next, the computer system may diagnose the network problem and may compute a second remedial action based at least in part on the diagnosis of the network problem. After receiving approval the computer system may automatically perform the second remedial action when a subsequent instance of the network problem is detected.

### FIELD

The described embodiments relate to techniques for dynamically assessing communication performance in a network and selectively providing remediation recommendations (such as a configuration change) to improve the communication performance or to prevent an occurrence of a network problem. Alternatively or additionally, the described embodiments relate to an interactive user interface that allows a user or an operator of a network to dynamically assess communication performance of the network.

### BACKGROUND

Many electronic devices are capable of wirelessly communicating with other electronic devices. In particular, these electronic devices can include a networking subsystem that implements a network interface for: a cellular network (UMTS, LTE, 5G-New Radio (NR):NG-Core, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network.

For example, many electronic devices communicate with each other via wireless local area networks (WLANs) using an IEEE 802.11-compatible communication protocol (which are sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

Wi-Fi has emerged as one of the cornerstone technologies of the mobile Internet, and the scale of Wi-Fi networks continues to increase. In the near future, carrier-class Wi-Fi networks are expected to contain several hundred thousand access points.

While large-scale Wi-Fi networks are popular because of their reduced cost, and increased coverage, and capacity, managing and maintaining such large networks can be challenging. Notably, configuration changes in different electronic devices or a subset of a large-scale Wi-Fi network (such as a zone) can impact the communication performance in a portion of the Wi-Fi network. However, it is often difficult to determine the relationship between a potential cause (e.g., a particular configuration change) and an effect (e.g., the communication performance in the portion of the Wi-Fi network). For example, many detection techniques are plagued by false positives or false alarms, especially given the dynamic and ad-hoc nature of Wi-Fi networks. Moreover, inaccurate detection techniques can result in significant expense and reduced communication performance in large Wi-Fi networks. Furthermore, given the dynamic and ad-hoc nature of Wi-Fi networks, it is typically difficult to know how and when to change the configuration of a Wi-Fi network to improve the communication performance. The reduced communication performance in large Wi-Fi networks can be frustrating to operators and can degrade the user experience of users of these Wi-Fi networks.

Similarly, when a problem occurs in a network (such as a Wi-Fi network), it is often difficult to diagnose or troubleshoot the problem and to determine the appropriate corrective or remedial action to perform. Notably, while customers often want to know what is wrong with their networks, they typically are less interested in being involved in the root-cause analysis process. Instead, from a customer perspective, the expectation is for zero downtime and no human or resource cost to troubleshoot or fix eventual network problems. However, meeting this expectation using existing network monitoring and analytical tools is usually challenging. This is also frustrating to the operators and can degrade the user experience of users of Wi-Fi networks.

### SUMMARY

In a first group of embodiments, a computer system (which may include one or more computers) is described. This computer system may include: an interface circuit, a memory that stores program instructions, and a processor that executes the program instructions. During operation, the computer system receives information specifying communication in a network (such as a wired and/or a wireless network). Then, the computer system detects a network problem based at least in part on the information. Moreover, the computer system determines a recommended configuration change for the network based at least in part on the detected network problem, where the recommended configuration change is predicted to improve communication performance of the network in at least a portion of the network. Next, the computer system implements the recommended configuration change. Furthermore, the computer system receives second information specifying second communication in the network after the recommended configuration change has been implemented. Additionally, the computer system selectively undoes the recommend configuration change based at least in part on the second information. More generally, the computer system may selectively perform a remedial action, which may include undoing the recommended configuration change and/or implementing another configuration change.

In some embodiments, the computer system may compute communication-performance metrics for the network based at least in part on the information. Moreover, the network problem may be detected based at least in part on the communication-performance metrics.

Note that the recommended configuration change may be determined using a pretrained model, such as a machine-learning model or a neural network. When determining the recommended configuration change, the communication-performance metrics may be input to the pretrained model and the recommended configuration change may be output from the pretrained model.

Furthermore, the communication-performance metrics may be associated with different portions of the network or different regions in the network. In some embodiments, the communication-performance metrics may be associated with different hierarchical levels in the network. For example, the network may be a WLAN that is compatible with an IEEE 802.11 standard, and the hierarchy may include: a zone, a WLAN group, a WLAN, a group of access points, and/or an access point.

Additionally, the computer system may provide the recommended configuration change, e.g., in a user interface. Then, the computer system may receive user-interface activity specifying a user selection associated with the recommended configuration change. In response to the user selection, the computer system may implement the recommended configuration change.

Moreover, the computer system may selectively undo the recommended configuration change based at least in part on detection of a communication performance in the network associated with the recommended configuration change.

Alternatively, or additionally, prior to selectively undoing the recommended configuration change, the computer system may provide second communication-performance metrics (e.g., in the user interface) associated with the second information and/or may receive second user-interface activity specifying a second user selection associated with the recommended configuration change. Moreover, the computer system may selectively undo the recommended configuration change based at least in part on the second user selection.

Note that the communication-performance metrics may be associated with connections in the network, infrastructure associated with the network (such as one or more controllers), and electronic devices in the network.

Another embodiment provides a user interface for presentation on a display associated with the computer system. This user interface may allow the operator of the network to dynamically assess communication performance of the network and to view and select recommended configuration changes.

Another embodiment provides a computer-readable storage medium for use with the computer system. When executed by the computer system, this computer-readable storage medium causes the computer system to perform at least some of the aforementioned operations.

Another embodiment provides a method, which may be performed by the computer system. This method includes at least some of the aforementioned operations.

In a second group of embodiments, a computer system (which may include one or more computers) is described. This computer system may include: an interface circuit, a memory that stores program instructions, and a processor that executes the program instructions. During operation, the computer system receives information specifying communication in a network (such as a wired and/or a wireless network). Then, the computer system detects a network problem based at least in part on the information. Moreover, the computer system automatically determines a remedial action based at least in part on the detected network problem, and automatically performs the determined remedial action. Alternatively, when the remedial action cannot be determined, the computer system selectively instruct one or more edge electronic devices or one or more controllers in the network to collect additional information for a predefined time interval. After receiving the additional information, the computer system diagnoses the network problem, and computes a second remedial action based at least in part on the diagnosis of the network problem. Next, the computer system provides information specifying the second remedial action for approval, and receives approval of the second remedial action, where, based at least in part on the received approval, the computer system automatically performs the second remedial action when a subsequent instance of the network problem is detected.

In some embodiments, the computer system may compute communication-performance metrics for the network based at least in part on the information. Moreover, the network problem may be detected based at least in part on the communication-performance metrics.

Note that the network problem may be detected using a pretrained model, such as a machine-learning model or a neural network. When detecting the network problem, the information may be input to the pretrained model and information specifying the network problem may be output from the pretrained model. Alternatively, or additionally, the remedial action may be determined using a rule engine, a look-up table or a second pretrained model, such as a machine-learning model or a neural network. When determining the remedial action, the information specifying the network problem may be used as an input and the remedial action may be an output from the rule engine, the look-up table or the second pretrained model.

Moreover, based at least in part on the received approval, the computer system may add the second remedial action to the rule engine, the look-up table or the second pretrained model.

Furthermore, when the subsequent instance of the network problem is detected, the second remedial action is automatically performed by the computer system in one or more portions of the network or one or more regions of the network associated with the network problem, such as a zone, a WLAN group, a WLAN, a group of access points, and/or an access point.

Additionally, the computer system may provide the information specifying second remedial action for approval by presenting the information specifying the second remedial action in a user interface, and the received approval may correspond to user-interface activity specifying a user selection in the user interface.

In some embodiments, the remedial action or the second remedial action may include a configuration change in the network.

Another embodiment provides an edge electronic device that performs counterpart operations to at least some of the aforementioned operations.

Another embodiment provides the user interface for presentation on a display associated with the computer system.

Another embodiment provides a computer-readable storage medium for use with the computer system or the edge electronic device. When executed by the computer system or the edge electronic device, this computer-readable storage medium causes the computer system or the edge electronic device to perform at least some of the aforementioned operations.

Another embodiment provides a method, which may be performed by the computer system or the edge electronic device. This method includes at least some of the aforementioned operations.

In a third group of embodiments, a computer system (which may include one or more computers) is described. This computer system may include: an interface circuit, a memory that stores program instructions, and a processor that executes the program instructions. During operation, the computer system receives information specifying a configuration change in a network (such as a wired and/or a wireless network). In response, the computer system dynamically computes a change in one or more communication-performance metrics based at least in part on time intervals before and after the configuration change. Moreover, the computer system provides a summary of the one or more communication-performance metrics.

Note that providing the summary may include presenting the summary in a table in a user interface.

Moreover, the computer system may receive information specifying the time intervals. For example, the computer system may receive user-interface activity associated with a user (such as an operator of the network) that specifies the time intervals. Notably, the user-interface activity may be associated with a calendar or a longitudinal timeline. In some embodiments, the user-interface activity may specify dynamic selection of configurable time intervals on the longitudinal timeline.

Alternatively, the computer system may automatically calculate or select the time intervals based at least in part on a type of the configuration change or a timestamp of the configuration change.

Furthermore, the configuration change may be included in a set of configuration changes that are arranged or filtered based at least in part on a hierarchy of electronic devices in the network. For example, the network may be a WLAN that is compatible with an IEEE 802.11 standard, and the hierarchy may include: a zone, a WLAN group, a WLAN, a group of access points, an access point, and an access-point firmware update.

Additionally, the one or more communication-performance metrics may include communication-performance metrics associated with: connections in the network, infrastructure associated with the network (such as one or more controllers), and electronic devices in the network.

In some embodiments, the computer system may automatically detect a communication-performance degradation associated with the configuration change, and may perform a remedial action. For example, the remedial action may include providing a recommended remedial action (such as a second configuration change) for approval by the operator of the network. Alternatively or additionally, the computer system may calculate a predicted communication-performance improvement associated with the configuration change, and the computer system may recommend the configuration change.

Another embodiment provides a user interface for presentation on a display associated with the computer system. This user interface may allow the operator of the network to dynamically assess an impact of configuration changes on communication performance of a network.

Another embodiment provides a computer-readable storage medium for use with the computer system. When executed by the computer system, this computer-readable storage medium causes the computer system to perform at least some of the aforementioned operations.

Another embodiment provides a method, which may be performed by the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices and computer network devices in a network in accordance with an embodiment of the present disclosure.

FIG. 2 is a flow diagram illustrating an example of a method for selectively undoing a recommended configuration change using a computer system in FIG. 1 in accordance with an embodiment of the present disclosure.

FIG. 3 is a drawing illustrating an example of communication between components in a computer system in FIG. 1 in accordance with an embodiment of the present disclosure.

FIG. 4 is a drawing illustrating an example of a user interface in accordance with an embodiment of the present disclosure.

FIG. 5 is a drawing illustrating an example of a user interface in accordance with an embodiment of the present disclosure.

FIG. 6 is a drawing illustrating an example of a user interface in accordance with an embodiment of the present disclosure.

FIG. 7 is a drawing illustrating an example of a user interface in accordance with an embodiment of the present disclosure.

FIG. 8 is a drawing illustrating an example of a user interface in accordance with an embodiment of the present disclosure.

FIG. 9 is a drawing illustrating an example of a user interface in accordance with an embodiment of the present disclosure.

FIG. 10 is a flow diagram illustrating an example of a method for performing a first group of operations or a second group of operations using a computer system in FIG. 1 in accordance with an embodiment of the present disclosure.

FIG. 11 is a drawing illustrating an example of communication between components in a computer system in FIG. 1 in accordance with an embodiment of the present disclosure.

FIG. 12 is a drawing illustrating an example of communication between components in a computer system in FIG. 1 in accordance with an embodiment of the present disclosure.

FIG. 13 is a drawing illustrating an example of communication between components in a computer system in FIG. 1 in accordance with an embodiment of the present disclosure.

FIG. 14 is a flow diagram illustrating an example of a method for dynamically assessing an impact of a configuration change in a network using a computer system in FIG. 1 in accordance with an embodiment of the present disclosure.

FIG. 15 is a drawing illustrating an example of communication between components in a computer system in FIG. 1 in accordance with an embodiment of the present disclosure.

FIG. 16 is a drawing illustrating an example of a user interface in accordance with an embodiment of the present disclosure.

FIG. 17 is a drawing illustrating an example of a user interface in accordance with an embodiment of the present disclosure.

FIG. 18 is a drawing illustrating an example of a user interface in accordance with an embodiment of the present disclosure.

FIG. 19 is a drawing illustrating an example of a user interface in accordance with an embodiment of the present disclosure.

FIG. 20 is a drawing illustrating an example of a user interface in accordance with an embodiment of the present disclosure.

FIG. 21 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system is described. During operation, the computer system may receive information specifying communication in a network (such as a wired and/or a wireless network). Then, the computer system may detect a network problem based at least in part on the information. Moreover, the computer system may determine a recommended configuration change for the network based at least in part on the detected network problem, where the recommended configuration change is predicted to improve communication performance of the network in at least a portion of the network. Note that the configuration change may be determined using a pretrained model, such as a machine-learning model or a neural network. Next, the computer system may implement the recommended configuration change. Furthermore, the computer system may receive second information specifying second communication in the network after the recommended configuration change has been implemented. Additionally, the computer system may selectively undo the recommend configuration change based at least in part on the second information. More generally, the computer system may selectively perform a remedial action, which may include undoing the recommended configuration change and/or implementing another configuration change.

By monitoring and adapting the configuration, these monitoring techniques may allow the network to be dynamically changed. This capability may allow a relationship between a potential cause (e.g., the configuration change) and an effect (e.g., to the communication performance of the network, such as one or more of communication-performance metrics) to be determined. These capabilities may facilitate accurate anomaly detection (e.g., with reduced false positives or false alarms) and remedial action to address a network problem, such as a component failure or communication-performance degradation in the network. Moreover, more accurate configuration changes may reduce the cost of monitoring and managing large networks. Consequently, the monitoring techniques may improve the communication performance of the network, which may improve the user experience of users and operators of the network.

In a second group of embodiments, a computer system is described. During operation, the computer system may receive information specifying communication in a network (such as a wired and/or a wireless network). Then, the computer system may detect a network problem based at least in part on the information. Note that the network problem may be determined using a pretrained model, such as a machine-learning model or a neural network. Moreover, the computer system may automatically determine a remedial action based at least in part on the detected network problem and may automatically perform the determined remedial action. In some embodiments, the remedial action is determined using a rule engine, a look-up table or a second pretrained model, such as a machine-learning model or a neural network. Alternatively, when the remedial action cannot be determined, the computer system may selectively instruct one or more edge electronic devices or one or more controllers in the network to collect additional information for a predefined time interval. After receiving the additional information, the computer system may diagnose the network problem, and may compute a second remedial action based at least in part on the diagnosis of the network problem. Next, the computer system may provide information specifying the second remedial action for approval, and may receive approval of the second remedial action, where, based at least in part on the received approval, the computer system may automatically perform the second remedial action when a subsequent instance of the network problem is detected.

By automatically determining and performing the remedial action when possible and, when it is not possible to determine the remedial action, by dynamically collecting additional data, diagnosing the network problem, computing the second remedial action, and receiving approval for the second remedial action, these monitoring techniques may provide automated feedback and continuous learning for the network. These capabilities may allow a relationship between a potential cause (e.g., a configuration) and an effect (e.g., the network problem) to be determined. These capabilities may facilitate accurate anomaly detection (e.g., with reduced false positives or false alarms) and appropriate corrective action (such as the remedial action or the second remedial action) to address the network problem, such as a component failure or communication-performance degradation in the network. Moreover, these capabilities may reduce the cost of monitoring and managing large networks. Consequently, the monitoring techniques may improve the communication performance of the network, which may improve the user experience of users and operators of the network.

In a third group of embodiments, a computer system is described. During operation, the computer system may receive information specifying a configuration change in a network (such as a wired and/or a wireless network). For example, the computer system may receive user-interface activity associated with a user (such as an operator of the network) that specifies the time intervals. Notably, the user-interface activity may specify dynamic selection of configurable time intervals on a longitudinal timeline. Moreover, the computer system may dynamically compute a change in one or more communication-performance metrics based at least in part on time intervals before and after the configuration change. Furthermore, the computer system may provide a summary of the one or more communication-performance metrics. Note that providing the summary may include presenting the summary in a table in a user interface. In some embodiments, the computer system may detect automatically detect a communication-performance degradation associated with the configuration change, and the computer system may perform a remedial action.

By dynamically assessing an impact of the configuration change on the network, these monitoring techniques may allow a relationship between a potential cause (e.g., the configuration change) and an effect (e.g., the one or more communication-performance metrics) to be determined. These capabilities may facilitate accurate anomaly detection (e.g., with reduced false positives or false alarms) and remedial action to address communication-performance degradation in the network. Moreover, more accurate detection techniques may reduce the cost of monitoring and managing large networks. Consequently, the monitoring techniques may improve the communication performance of the network, which may improve the user experience of users and operators of the network.

In the discussion that follows, electronic devices (such as an access point or an eNodeB or an gNodeB) communicate frames or packets with another electronic device (such as a recipient electronic device, which is sometimes referred to as a ‘client’) in accordance with one or more wireless communication protocol, such as an IEEE 802.11 standard (which is sometimes referred to as ‘Wi-Fi,’ from the Wi-Fi Alliance of Austin, Texas), Bluetooth (from the Bluetooth Special Interest Group of Kirkland, Washington), BLE (from the Bluetooth Special Interest Group of Kirkland, Washington), Zigbee (from the Zigbee Alliance of Davis, California), Z-Wave (from Sigma Designs, Inc. of Fremont, California), LoRaWAN (from the Lora Alliance of Beaverton, Oregon), Thread (from the Thread Group of San Ramon, California), IPV6 over low-power wireless personal area networks or 6LoWPAN (from the Internet Engineering Taskforce of Fremont, California) and/or another type of wireless interface. In the discussion that follows, Wi-Fi is used as an illustrative example. Note that an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

However, a wide variety of communication protocols (such as Long-Term Evolution or LTE, another cellular-telephone communication protocol, etc.) may be used. The wireless communication may occur in one or more bands of frequencies, such as: a 900 MHZ, a 2.4 GHz, a 5 GHz, 6 GHZ, the Citizens Broadband Radio Spectrum or CBRS (e.g., a frequency band near 3.5 GHZ), a band of frequencies used by LTE or another cellular-telephone communication protocol or a data communication protocol, and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’) In some embodiments, communication between electronic devices may use multi-user transmission (such as orthogonal frequency division multiple access or OFDMA).

Moreover, the access point, eNodeB or gNodeB may communicate with other access points, eNodeBs, computer network devices (such as a router or a switch), computers and/or computer systems in a network using a wired communication protocol, such as an IEEE 802.3 standard (which is sometimes referred to as ‘Ethernet’), Message Queueing Telemetry Transport (MQTT) and/or another type of wired interface. In the discussion that follows, Ethernet is used as an illustrative example.

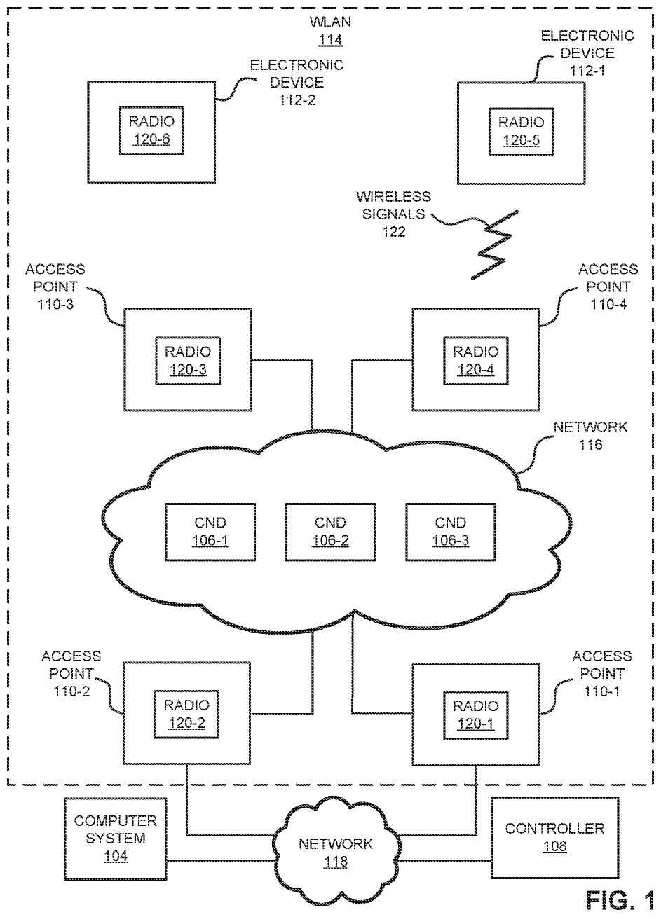

FIG. 1 presents a block diagram illustrating an example of communication among one or more access points (APs) 110 and electronic devices 112 (such as a cellular telephone or a smartphone, and which are sometimes referred to as ‘stations’ or ‘clients’) in a WLAN 114 (which is used as an example of a wireless network) in accordance with some embodiments. Access points 110 may communicate with each other in WLAN 114 using wireless and/or wired communication (such as by using Ethernet or a communication protocol that is compatible with Ethernet). Note that access points 110 may include a physical access point and/or a virtual access point that is implemented in software in an environment of an electronic device or a computer. In addition, at least some of access points 110 (such as access points 110-3 and 110-4) may communicate with electronic devices 112 using wireless communication.

The wired and/or wireless communication among access points 110 in WLAN 114 may occur via network (e.g., a public data network or PDN) 116 (such as an intra-net, a mesh network, point-to-point connections and/or the Internet) and may use a network communication protocol, such as Ethernet. For example, WLAN 114 may include computer network devices (CND) 106 (e.g., a switch or a router). In some embodiments, the one or more computer network device 106 may include a stack of multiple computer network devices (which are sometimes referred to as ‘stacking units’).

Furthermore, the wireless communication using Wi-Fi may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication among access points 110 also involves the use of dedicated connections, such as via a peer-to-peer (P2P) communication technique. Therefore, access points 110 may support wired communication outside of WLAN 114 (such as Ethernet) and wireless communication within WLAN 114 (such as Wi-Fi), and one or more of access points 110 may also support a wired communication protocol for communicating via network 118 with electronic devices (such as one or more computers associated with computer system 104 or a controller 108, e.g., of WLAN 114, which may be remoted located from WLAN 114). Note that controller 108 may configure or provision the one or more computer network devices 106 and/or access points 110.

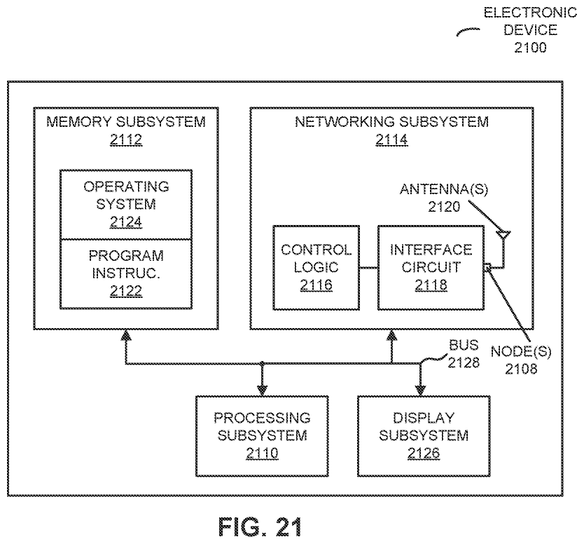

As described further below with reference to FIG. 21, the one or more computer network device 106, access points 110, electronic devices 112, controller 108 and/or computer system 104 may include subsystems, such as a networking subsystem, a memory subsystem and a processor subsystem. In addition, access points 110 and electronic devices 112 may include radios 120 in the networking subsystems. More generally, access points 110 and electronic devices 112 can include (or can be included within) any electronic devices with the networking subsystems that enable access points 110 and electronic devices 112 to communicate with each other using wireless and/or wired communication. This wireless communication can include transmitting advertisements on wireless channels to enable access points 110 and/or electronic devices 112 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 120 are shown in access points 110 and electronic devices 112, one or more of these instances may be different from the other instances of radios 120.

As can be seen in FIG. 1, wireless signals 122 (represented by a jagged line) are transmitted from radio 120-4 in access point 110-4. These wireless signals may be received by radio 120-5 in electronic device 112-1. Notably, access point 110-4 may transmit packets or frames. In turn, these packets or frames may be received by electronic device 112-1. Moreover, access point 110-4 may allow electronic device 112-1 to communicate with other electronic devices, computer system 104, computer network devices 106, controller 108, computers and/or servers via networks 116 and/or 118.

Note that the communication among access points 110 and/or with electronic devices 112 (and, more generally, communication among components in WLAN 114) may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in computer network devices 108, access points 110 and/or electronic devices 112 includes: receiving signals (such as wireless signals 122) corresponding to the packet or frame: decoding/extracting the packet or frame from received wireless signals 122 to acquire the packet or frame: and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As noted previously, it can be difficult to monitor and manage large networks (such as a wired and/or a wireless network). For example, it can be difficult to assess the impact of configuration changes to maintain performance of the network.

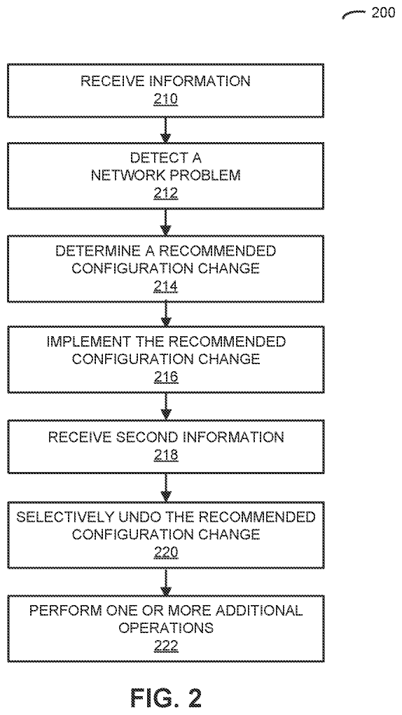

To address these problems, as described further below with reference to FIGS. 2-9, the disclosed monitoring technique may allow a user (such as an operator of a network, such as WLAN 114) to use a computer system (such as computer system 104) to dynamically assess communication performance of a network, detect a network problem (such as a reduced communication performance, an incorrect configuration, e.g., an access-point firmware update, and/or a component failure) and to perform an appropriate action, such as: implementing a configuration change: and/or selectively undoing a configuration change when it proves to be counterproductive (e.g., when the communication performance is degraded following the configuration change).

Notably, computer system 104 may receive information specifying communication in a network, such as: WLAN 114, network 116 and/or network 118. For example, computer system 104 may receive the information from: access points 110, computer network devices 106 and/or controller 108. Alternatively, or additionally, computer system 104 may access the information, e.g., in a memory in or associated with computer system 104.

Then, computer system 104 may detect a network problem based at least in part on the information. For example, computer system 104 may compute communication-performance metrics (such as throughputs) for the network based at least in part on the information. Moreover, the network problem may be detected based at least in part on the communication-performance metrics, such as based at least on a comparison of the communication-performance metrics with stored historical values of the communication-performance metrics and/or expected values of the communication-performance metrics (e.g., for the current configuration of the network). In some embodiments, the expected values of the communication-performance metrics may be determined using a pretrained model (such as a machine-learning model or a neural network) that outputs the expected or predicted values of the communication-performance metrics based at least in part on the configuration, loading of access points 110, a number of clients in the network (such as electronic devices 112), utilizations, capacities, bandwidths, data rates, and/or one or more other parameters or factors.

Note that the communication-performance metrics may be associated with different portions of the network or different regions in the network. In some embodiments, the communication-performance metrics may be associated with different hierarchical levels in the network. For example, the network may be a WLAN that is compatible with an IEEE 802.11 standard, and the hierarchy may include: a zone, a WLAN group, a WLAN, a group of access points, and/or a given access point.

Moreover, computer system 104 may determine a recommended configuration change for the network based at least in part on the detected network problem, where the recommended configuration change is predicted to improve communication performance of the network in at least a portion of the network. Note that the recommended configuration change may be determined using the same or a different pretrained model, such as a machine-learning model or a neural network. When determining the recommended configuration change, the communication-performance metrics may be input to the pretrained model and the recommended configuration change may be output from the pretrained model. Alternatively or additionally, the recommended configuration change may be determined using a look-up table with historical configurations (such as values of different configuration parameters or factors) and corresponding communication-performance metrics.

In some embodiments, computer system 104 may provide the recommended configuration change, e.g., in a user interface on a computer (in computer system 104 or, in embodiments where the computer is separate from computer system 104, not shown) used by a network operator. Then, computer system 104 may receive user-interface activity specifying a user selection (e.g., by the network operator) associated with the recommended configuration change. For example, the network operator may provide the user-interface activity by using: a keyboard, a touch-sensitive display, another human-interface device, a voice interface, etc. In response to the user selection, computer system 104 may implement the recommended configuration change. Alternatively, computer system 104 may automatically implemented the recommended configuration change without approval or an instruction from the network operator.

Next, computer system 104 may receive second information specifying second communication in the network after the recommended configuration change has been implemented. For example, computer system 104 may receive the second information from: access points 110, computer network devices 106 and/or controller 108. Alternatively or additionally, computer system 104 may access the second information, e.g., in a memory in or associated with computer system 104. Note that the second information may include some or all information (e.g., sampled or continuous monitoring) associated with or specifying the second communication following the recommended configuration change in a predefined time interval (such as 12 hrs, 1 day, 7 days, 14 days, 30 days, etc.). This predefined time interval is sometimes referred to as a ‘monitoring phase.”

Furthermore, computer system 104 may selectively undo the recommend configuration change based at least in part on the second information. (More generally, computer system 104 may selectively perform a remedial action, which may include undoing the recommended configuration change and/or implementing another configuration change.) For example, computer system 104 may compute second communication-performance metrics (such as throughputs) for the network based at least in part on the second information. For example, computer system 104 may compute the second communication-performance metrics in one or more time intervals (such as 12 hrs., 1 day, 3 days or a 1 week) after the recommended configuration change has been implemented. Additionally, computer system 104 may selectively undo the recommended configuration change based at least in part on detection of a communication performance in the network associated with the recommended configuration change. Thus, when the second communication-performance metrics indicate that the communication performance is less than expected or predicted, computer system 104 may selectively undo the recommend configuration change.

Alternatively, or additionally, prior to selectively undoing the recommended configuration change, computer system 104 may provide the second communication-performance metrics (e.g., in the user interface on the computer used by the network operator). For example, computer system 104 may provide the second communication-performance metrics in different time intervals after the recommended configuration change has been implemented, such as in a table and/or a timeline displayed in the user interface on the computer of the network operator. Then, computer system 104 may receive second user-interface activity (e.g., by the network operator) specifying a second user selection associated with the recommended configuration change. In response, computer system 104 may selectively undo the recommended configuration change based at least in part on the second user selection.

Note that the communication-performance metrics and/or the second communication-performance metrics may be associated with: connections in the network, infrastructure associated with the network (such as one or more controllers), e.g., controller 108), and electronic devices 112 in the network.

In some embodiments, a given pretrained predictive model may include a classifier or a regression model that was trained using: a support vector machine technique, a classification and regression tree technique, least-squares regression, logistic regression, another regression technique, lasso logistic regression, LASSO, logistic linear regression, a neural network technique (such as a convolutional neural network technique, a generative adversarial network or another type of neural network technique) and/or another linear or nonlinear supervised-learning technique.

While the preceding discussion illustrated the use of interactions associated a displayed user interface in the monitoring techniques, in other embodiments a variety of techniques may be used to facilitate the interaction between the user (such as the network operator) and the computer (such as by providing or specifying information using a keyboard, a touch-sensitive display, another human-interface device, a voice interface, etc.).

Moreover, in some embodiments, the recommended configuration change may be based at least in part on comparisons with historical communication-performance metrics and configurations of one or more different networks, different subnets, and/or different controllers. This historical information may be used to, e.g., identify an opportunity cost (such as a sub-optimal communication performance in a given network) and to determine a recommended configuration change (which may include an estimated or predicted improvement in the communication performance of the given network).

In these ways, computer system 104 may dynamically assess communication performance in a network, automatically detect one or more network problems (e.g., in different levels in the hierarchy), automatically determine a recommended configuration change, and/or selectively perform remedial or corrective action (such as undoing the recommended configuration change) based at least in part on a resulting communication performance of the network. These capabilities may allow computer system 104 to assist the user by dynamically adapting the configuration of the network to changes, such as to the communication performance and/or the wireless environment. Therefore, the monitoring techniques may simplify monitoring and management of the network, may improve communication performance of the network, and, thus, may improve the user experience when using the network.

Moreover, as noted previously, it can be difficult to diagnose a network problem and to determine an appropriate remedial action. Furthermore, in the absence of feedback in the network, it can be difficult to perform continuous learning.

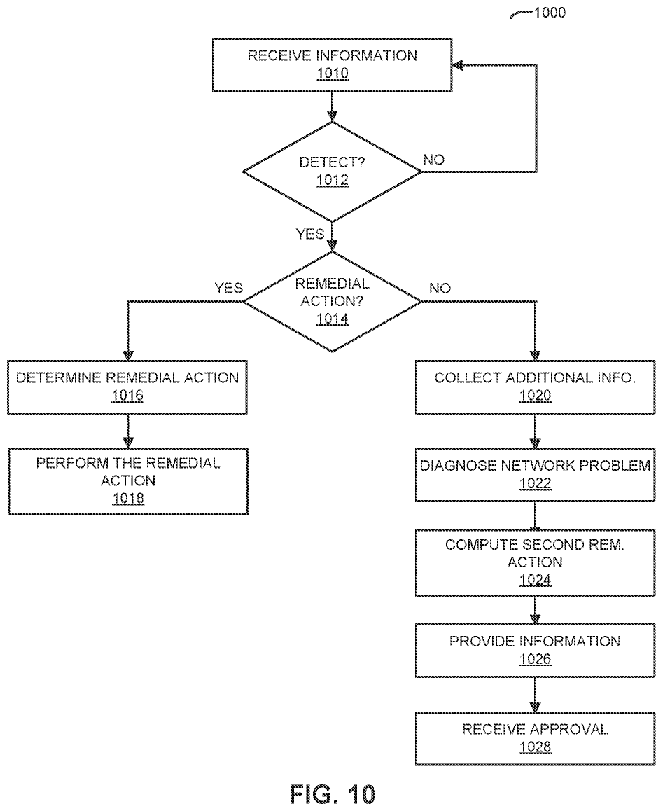

To address these problems, as described further below with reference to FIGS. 10-13, in the disclosed monitoring technique may allow a computer system (such as computer system 104) to dynamically assess communication performance of a network, detect a network problem (such as a reduced communication performance, an incorrect configuration, e.g., an access-point firmware update, and/or a component failure) and perform an appropriate remedial action (such as implementing a configuration change, updating firmware, replacing a failed component and/or restoring functionality associated with a failed component). Alternatively, when the remedial action cannot be determined (or is unavailable), perform continuous learning to dynamically collect additional data, diagnose the network problem compute and receive approval for another remedial action for the network problem.

Notably, computer system 104 may receive information specifying communication in a network, such as: WLAN 114, network 116 and/or network 118. For example, computer system 104 may receive the information from: access points 110, computer network devices 106 and/or controller 108. Alternatively, or additionally, computer system 104 may access the information, e.g., in a memory in or associated with computer system 104.

Then, computer system 104 may detect a network problem based at least in part on the information. For example, computer system 104 may compute communication-performance metrics (such as throughputs, mean-time-to-repair, etc.,) for the network based at least in part on the information. Moreover, the network problem may be automatically detected based at least in part on the information and/or the communication-performance metrics, such as based at least on a comparison of the communication-performance metrics with stored historical values of the communication-performance metrics and/or expected values of the communication-performance metrics (e.g., for the current configuration of the network). Notably, the network problem may be detected using a pretrained model (such as a machine-learning model or a neural network). When detecting the network problem, the information and/or the communication-performance metrics may be input to the pretrained model and information specifying the network problem may be output from the pretrained model. In some embodiments, the expected values of the communication-performance metrics may be determined using the same or a different pretrained model (such as a machine-learning model or a neural network) that outputs the expected or predicted values of the communication-performance metrics based at least in part on the information, the configuration, loading of access points 110, a number of clients in the network (such as electronic devices 112), utilizations, capacities, bandwidths, data rates, and/or one or more other parameters or factors.

Note that the communication-performance metrics may be associated with different portions of the network or different regions in the network. In some embodiments, the communication-performance metrics may be associated with different hierarchical levels in the network. For example, the network may be a WLAN that is compatible with an IEEE 802.11 standard, and the hierarchy may include: a zone, a WLAN group, a WLAN, a group of access points, and/or a given access point.

Moreover, computer system 104 may automatically determine a remedial action for the network based at least in part on the detected network problem, where the remedial action address, at least in part, the detected network problem (e.g., by improving communication performance of the network in at least a portion of the network). Note that the recommended configuration change may be determined using another pretrained model (which may be the same as or different from one of the other embodiments of the pretrained model), such as a machine-learning model or a neural network. When determining the remedial action, information specifying the determined network problem may be input to the other pretrained model and the remedial action may be output from the other pretrained model. Alternatively, or additionally, the remedial action may be determined using a rule engine or a look-up table by using the information specifying the network problem as an input and the remedial action may be an output from the rule engine or the look-up table. After determining the remedial action, computer system 104 may automatically perform the determined remedial action (such as changing a configuration of a portion of the network or a region in the network).

Alternatively, when the remedial action cannot be determined or is unavailable (such as a remedial action for the detected network problem does not exist or is not predicted to improve the communication performance of the network), computer system 104 may selectively collect additional information for a predefined time interval (such as 10 min. or until turned off by a network operation of the network). For example, computer system may selectively instruct one or more edge electronic devices (such as one or more access points 110) and/or one or more controllers (such as controller 108) in the network to collect additional data. After receiving the additional data or information, computer system 104 may diagnose the network problem, and may compute a second remedial action (such as another change to a configuration of the same or another portion of the network or in the same or another region in the network) based at least in part on the diagnosis of the network problem.

Next, computer system 104 may provide, for approval, information specifying the second remedial action, e.g., in a user interface on a computer (in computer system 104 or, in embodiments where the computer is separate from computer system 104, not shown) used by a network operator. Then, computer system 104 may receive user-interface activity specifying a user selection (e.g., by the network operator) associated with the second remedial action. For example, the network operator may provide the user-interface activity by using: a keyboard, a touch-sensitive display, another human-interface device, a voice interface, etc. This user-interface activity may indicate that the second remedial action is approved for use with the network problem. In response to the user selection, computer system 104 may update the other pretrained model, the look-up table and/or the rule engine that is used to determine the remedial action. Consequently, when a subsequent instance of the network problem is detected, computer system 104 may automatically perform the second remedial action, e.g., in one or more portions of the network or one or more regions of the network associated with the network problem, such as a zone, a WLAN group, a WLAN, a group of access points 110, an access point (such as access point 110-1), a group of computer network devices 106, and/or a computer network device (such as computer network device 106-1.

In these ways, computer system 104 may provide automated feedback and continuous learning for the network. These capabilities may allow computer system 104 to assist a user (such as the network operator) by diagnosing network problems, dynamically collecting additional data, and updating or computing new remedial actions, such as configuration changes that impact the communication performance and/or the wireless environment. Therefore, the monitoring techniques may simplify and reduce the cost of monitoring and management of the network, may improve communication performance of the network, and, thus, may improve the user experience when using the network.

Furthermore, as noted previously, it can be difficult to monitor and manage large networks (such as a wired and/or a wireless network). For example, it can be difficult to assess the impact of configuration changes in order to maintain performance of the network.

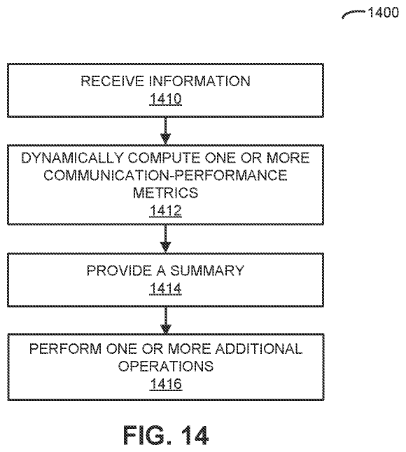

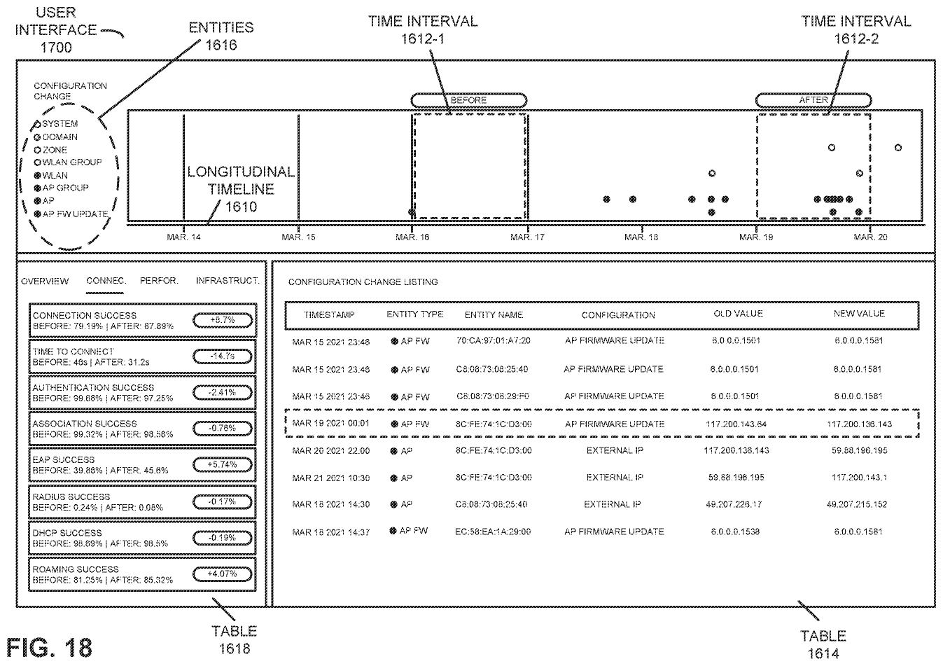

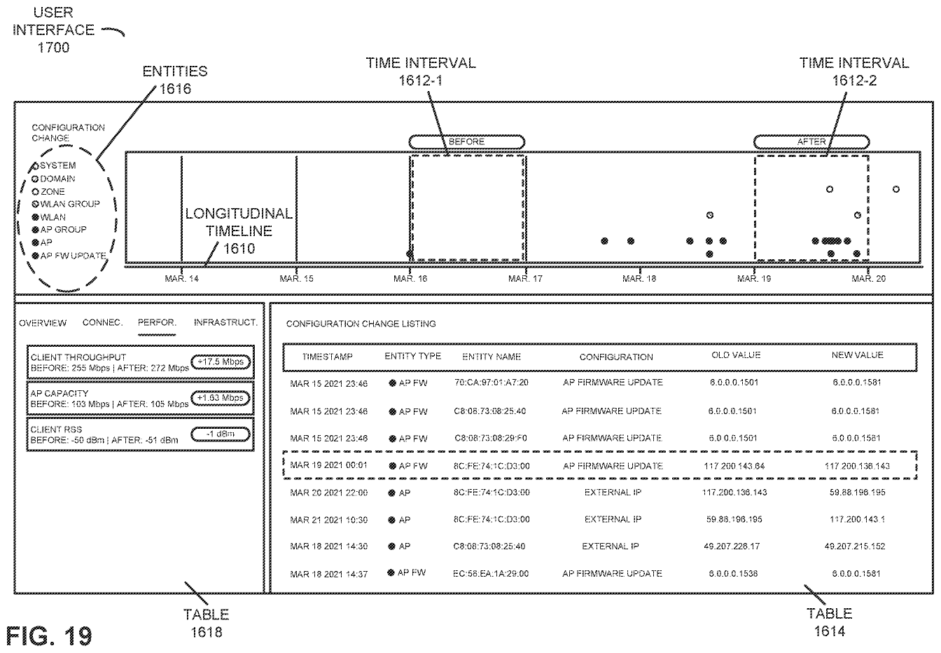

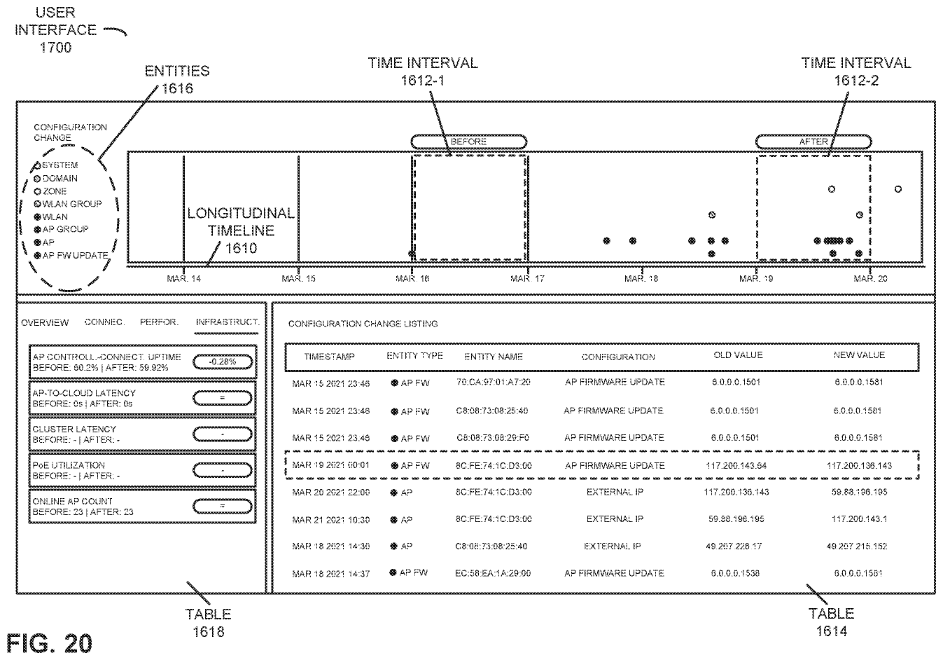

In order to address these problems, as described further below with reference to FIGS. 14-20, the disclosed monitoring technique may allow a user (such as an operator of a network, such as WLAN 114) to use a computer (such as computer system 104) to dynamically assess the impact of a configuration change in the network. Notably, the user may specify the configuration change in network. For example, the user may select a particular configuration change from a list of configuration changes that is presented in a user interface. More generally, the user may provide information that specifies the configuration change (such as by using a keyboard, a touch-sensitive display, another human-interface device, a voice interface, etc.).

In response, the computer may dynamically compute a change in one or more communication-performance metrics based at least in part on time intervals before and after the configuration change. Note that the one or more communication-performance metrics may include communication-performance metrics associated with: connections in the network, infrastructure associated with the network (such as one or more controllers, e.g., control 108), and electronic devices in the network.

In some embodiments, the user may specify the time intervals, e.g., by dynamically interacting with the user interface via their user-interface activity. For example, the user may dynamically interact with a longitudinal timeline object in the user interface to specify the time intervals, such as by configuring the size and/or locations of the time intervals. Alternatively or additionally, the user may select or specify the time intervals using a calendar object that is included in the user interface. More generally, the user may provide information that specifies the time intervals (such as by using a keyboard, a touch-sensitive display, another human-interface device, a voice interface, etc.). However, in other embodiments, the computer may automatically (i.e., without user action) calculate or select the time intervals based at least in part on a type of the configuration change or a timestamp of the configuration change. For example, the time intervals may be automatically selected to be 24 hours before and after the configuration change. The user may then have the option to change the automatically selected time intervals if they choose to do so.

Moreover, the computer may provide a summary of the one or more communication-performance metrics. For example, the computer may provide the summary in a table in the user interface.

Furthermore, the configuration change may be included in a set of configuration changes that are arranged or filtered based at least in part on a hierarchy of electronic devices in the network. For example, the network may be a WLAN that is compatible with an IEEE 802.11 standard, and the hierarchy may include: a zone, a WLAN group, a WLAN, a group of access points, an access point, and an access-point firmware update. Consequently, using the user interface, the user may be able to view the impact of the configuration change on the one or more communication-performance metrics of electronic devices at different levels in the hierarchy by selecting or specifying a given level that is of interest to the user.

In some embodiments, the computer may automatically detect a communication-performance degradation associated with the configuration change, and may perform a remedial action. For example, the remedial action may include providing a recommended remedial action (such as a second configuration change) for approval by the operator of the network.

Alternatively or additionally, the computer may calculate a predicted communication-performance improvement associated with the configuration change, and the computer may recommend the configuration change. For example, the prediction may be made using a pretrained predictive model, such as a machine-learning model or a neural network. In some embodiments, the pretrained predictive model may include a classifier or a regression model that was trained using: a support vector machine technique, a classification and regression tree technique, logistic regression, LASSO, linear regression, a neural network technique (such as a convolutional neural network technique, a generative adversarial network or another type of neural network technique) and/or another linear or nonlinear supervised-learning technique. Thus, in some embodiments, instead of a user initiating the configuration change on their own, the computer may suggest the configuration change to the user. Nonetheless, after the configuration change has been implemented, the monitoring techniques may allow a user to interact with the computer to obtain information to dynamically assess the impact of the configuration change. While the preceding discussion illustrated the use of interactions associated a displayed user interface in the monitoring techniques, in other embodiments a variety of techniques may be used to facilitate the interaction between the user and the computer (such as by providing or specifying information using a keyboard, a touch-sensitive display, another human-interface device, a voice interface, etc.).

In these ways, the monitoring techniques may dynamically interact with the computer in order to obtain (e.g., view) one or more communication-performance metrics associated with a configuration change in the network. These capabilities may allow the user to assess cause and effect between the configuration change and temporal changes in the one or more communication-performance metrics. In some embodiments, information associated with the monitoring techniques is presented in an intuitive manner using a longitudinal timeline object in a user interface. Moreover, the monitoring techniques may allow the user and/or the computer to perform appropriate remedial or corrective action based at least in part on the temporal changes in the one or more communication-performance metrics. Therefore, the monitoring techniques may simplify monitoring and management of the network, may improve communication performance of the network, and, thus, may improve the user experience when using the network.

We now describe embodiments of a method. FIG. 2 presents a flow diagram illustrating an example of a method 200 for selectively undoing a recommended configuration change in a network using a computer system (such as computer system 104 or a controller 108 in FIG. 1). During operation, the computer system may receive information (operation 210) specifying communication in a network (such as a wired and/or a wireless network).

Then, the computer system may detect a network problem (operation 212) based at least in part on the information. Moreover, the computer system may determine a recommended configuration change (operation 214) for the network based at least in part on the detected network problem, where the recommended configuration change is predicted to improve communication performance of the network in at least a portion of the network.

Note that the recommended configuration change may be determined using a pretrained model, such as a machine-learning model or a neural network. When determining the recommended configuration change, the communication-performance metrics may be input to the pretrained model and the recommended configuration change may be output from the pretrained model.

Next, the computer system may implement the recommended configuration change (operation 216). Furthermore, the computer system may receive second information (operation 218) specifying second communication in the network after the recommended configuration change has been implemented.

Additionally, the computer system may selectively undo the recommend configuration change (operation 220) based at least in part on the second information. More generally, the computer system may selectively perform a remedial action, which may include undoing the recommended configuration change and/or implementing another configuration change.

In some embodiments, the computer system may optionally perform one or more additional operations (operation 222). Notably, the computer system may compute communication-performance metrics for the network based at least in part on the information. Moreover, the network problem may be detected based at least in part on the communication-performance metrics.

Furthermore, the communication-performance metrics may be associated with different portions of the network or different regions in the network. In some embodiments, the communication-performance metrics may be associated with different hierarchical levels in the network. For example, the network may be a WLAN that is compatible with an IEEE 802.11 standard, and the hierarchy may include: a zone, a WLAN group, a WLAN, a group of access points, and/or an access point.

Additionally, the computer system may provide the recommended configuration change, e.g., in a user interface. Then, the computer system may receive user-interface activity specifying a user selection associated with the recommended configuration change. In response to the user selection, the computer system may implement the recommended configuration change.

Moreover, the computer system may selectively undo the recommended configuration change based at least in part on detection of a communication performance in the network associated with the recommended configuration change.

Alternatively or additionally, prior to selectively undoing the recommended configuration change, the computer system may provide second communication-performance metrics (e.g., in the user interface) associated with the second information and/or may receive second user-interface activity specifying a second user selection associated with the recommended configuration change. Moreover, the computer system may selectively undo the recommended configuration change based at least in part on the second user selection.

Note that the communication-performance metrics may be associated with: connections in the network, infrastructure associated with the network (such as one or more controllers), and electronic devices in the network.

In some embodiments of method 200, there may be additional or fewer operations. Furthermore, the order of the operations may be changed, and/or two or more operations may be combined into a single operation.

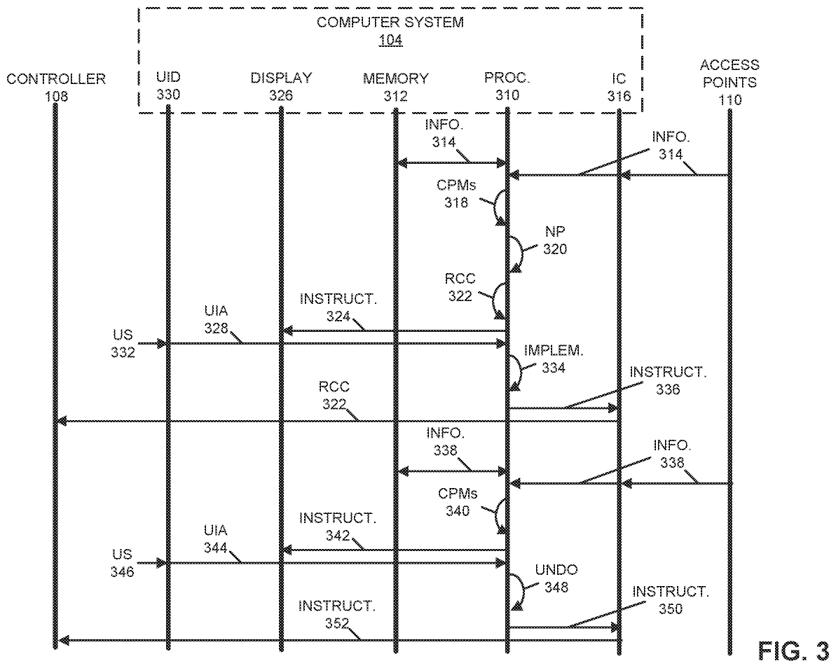

FIG. 3 presents a drawing illustrating an example of communication between components in a computer system 104. Notably, processor 310 in computer system 104 may access information 314 specifying communication in a network in memory 312 in computer system 104. Alternatively or additionally, information 314 may be received by interface circuit (IC) 316 in computer system 104, e.g., from access points 110. For example, information 314 may include: real-time network data, communication-performance metrics and/or client data. Then, processor 310 may optionally compute communication-performance metrics (CPMs) 318 for the network based at least in part on information 314. Moreover, processor 310 may detect a network problem (NP) 320 based at least in part on information 314 and/or the communication-performance metrics 318.

Furthermore, processor 310 may determine a recommended configuration change (RCC) 322 for the network based at least in part on the detected network problem 320. In some embodiments, processor 310 may optionally instruct 324 display 326 in computer system 104 to present the recommended configuration change 322, e.g., in a user interface for approval by a network operator. Then, a user-interface device (UID) 330 in computer system 104 may optionally provide, to processor 310, user-interface activity (UIA) 328 specifying a user selection (US) 332 (e.g., by the network operator). For example, the network operator may approve implementation of the recommended configuration change 322. In response to user selection 332 specified by user-interface activity 328 or without a user instruction (e.g., automatically), processor 310 may implement 334 the recommended configuration change 322. For example, processor 310 may instruct 336 interface circuit 316 to provide the recommended configuration change 322 to controller 108.

Next, processor 310 may access information 338 specifying second communication in the network in memory 312. Alternatively or additionally, information 338 may be received by interface circuit 316, e.g., from access points 110. For example, information 338 may include: real-time network data, communication-performance metrics and/or client data. Then, processor 310 may optionally compute communication-performance metrics (CPMs) 340 for the network based at least in part on information 338.

In some embodiments, processor 310 may optionally instruct 342 display 326 to present the communication-performance metrics 340, e.g., in the user interface for approval by the network operator. Then, a user-interface device 330 may optionally provide, to processor 310, user-interface activity (UIA) 344 specifying a user selection 346 (e.g., by the network operator). For example, the network operator may indicate that the recommended configuration change 322 be undone. In response to user selection 346 specified by user-interface activity 344 or without a user instruction (e.g., automatically), processor 310 may selectively undo 348 the recommended configuration change 322. For example, processor 310 may instruct 350 interface circuit 316 to provide an instruction 352 to undo the recommended configuration change 322 to controller 108.

While FIG. 3 illustrates communication between components using unidirectional or bidirectional communication with lines having single arrows or double arrows, in general the communication in a given operation in FIG. 3 may involve unidirectional or bidirectional communication.

We now further describe the monitoring techniques. Determining a dynamic configuration of a wireless network is often complicated by static factors (such as system/feature configuration) and dynamic factors (communication-performance metrics, types of clients, traffic pattern, etc.). It is often very difficult for a network operator or administrator to tune the configuration to achieve optimum communication performance for the communication-performance metrics (which are sometimes referred to as key performance indicators or KPIs) and/or user experience. In the disclosed monitoring techniques, a machine-learning recommendation engine and recommendation workflow are used for network performance improvement and/or user experience improvement for wireless clients/electronic devices.

A variety of problems can occur in networks. For example, there may be an anomaly or an outage that results in a severe communication-performance degradation. In principle, when an anomaly, outage and/or severe communication-performance degradation is detected, the next action would be to address the anomaly by making physical and/or software configuration changes. Alternatively, there may be a sub-optimal network communication performance. Because a network may continue to operate with sub-optimal communication performance, a network operator or administrator (who is sometimes referred to as a ‘user’) may not realize there is a problem. In principle, in order to best leverage the investment in high-end network equipment, a network should deliver the optimal communication performance and key performance indicators.

However, it is often difficult to achieve these goals. Notably, there are typically hundreds of static and dynamic factors or variables, such as: the system configuration, physical deployment, network configuration, Wi-Fi feature configuration and tuning parameters, types of clients, client operating systems, traffic pattern, usage pattern etc. Tuning one feature may improve one set of communication-performance metrics, but may degrade another set of communication-performance metrics. It is typically difficult to identify if a ripple effect in the communication-performance metrics is the result of the dynamic nature of clients and the usage pattern or is it because of a change in the configuration parameters. For example, network operators and administrators are usually unable to monitor the impact of changes in several of the available configuration parameters. Therefore, network operators and administrators typically cannot understand all the feature configuration parameters and to tune the ones that give improved or optimal communication performance

Note that current approaches to managing these problems include attempting to address an anomaly, outage and/or severe communication-performance degradation using network and Wi-Fi experts, who are consulted to look in the communication-performance metrics, network topology, client types and/or distribution, system/feature configuration. Using their domain knowledge and past experience, these experts may study the information, fine tune the network and perform measures in an iterative fashion until optimal communication performance is achieved. However, this process typically takes few days to few weeks to measure the communication-performance metrics and to optimize the network. Therefore, it is at best poorly suited to address dynamic challenges.

Consequently, the problem of sub-optimal network communication performance usually goes unnoticed or undetected. In some cases, even if sub-optimal communication performance is detected, a network operator or administrator may typically avoid making any configuration change in a ‘working’ network out of fear of further degrading the communication performance or causing an unwanted issue.

In the disclosed monitoring techniques, the recommendation engine may: monitor dynamic factors and may look for opportunities to change or tune configuration parameters with the goal of improving key performance indicators and/or user experience: have knowledge from similar deployment and learnings of the optimal communication performance and configuration: have access to knowledge from domain experts (such as whether dynamic frequency selection in a 5 GHz band of frequencies restricts usage or not, co-channel interference, etc.): and/or have the ability to continuously learn to deliver improved recommendations.

The monitoring techniques may: provide a 360° recommendation workflow: generate a recommendation when a problem is detected (such as when a sub-optimal key performance indicator is detected): apply the recommendation, which may be performed automatically (e.g., a non-peak hour or time of day) or based at least in part on a manual selection by a network operator or administrator (e.g., at a scheduled day/time): monitor the impact of the recommendation (e.g., for a time period): provide a comparison to the network administrator of before and after key performance indicators: and/or selectively revert or undo a recommendation automatically (e.g., a non-peak hour or time of day) or based at least in part on a manual selection by a network operator or administrator (e.g., at a scheduled day/time).

In some embodiments, the recommendation engine may generate recommendations that may be visible to users through a recommendation workflow. For example, the recommendation workflow may allow a network administrator or operator to: view a recommendation: view key performance indicators/statistics: understand recommendation benefits and side effects: select or apply a recommendation (such as configuration change in a controller): monitor key performance indicator before and/or after a recommendation is applied: and/or selectively revert or undo a recommendation. During this recommendation workflow, the recommendation engine may: collect statistics: compute key performance indicators: detect a network problem: assess a configuration: generate or monitor a recommendation: and/or apply or revert a recommendation. Moreover, this workflow may be repeated: continuously, periodically (such as hourly, daily or weekly), or as-needed (such as when there are significant changes in a network).

Note that the recommendation from the recommendation engine may also be consumed by: incidents: an analytics engine (such as a pretrained model in a cloud-based analytics service): and/or autonomous network management. Moreover, the recommendation knowledgebase may include and/or may capture: granular communication-performance metrics and key performance indicators: network and Wi-Fi factors affecting the communication-performance metrics and key performance indicators: client devices affecting the communication-performance metrics and key performance indicators: and/or configure settings and parameters affecting the communication-performance metrics and key performance indicators. Furthermore, during the monitoring techniques, the recommendation knowledgebase may be built from or using: domain expertise: machine learning of current and historical communication-performance metrics and recommendations. Additionally, during the monitoring techniques, the recommendation knowledge graph may be optimized using continuous learning of dynamic and static factors: and/or communication-performance metrics and key performance indicators before and after a recommendation was applied. Note that during the recommendation workflow, a recommendation may have a status to let a network operator or administrator assess the current state of the recommendation. For example, the status may be: new, scheduled for application, applied, scheduled for reversion, reverted, failed, and/or interrupted.

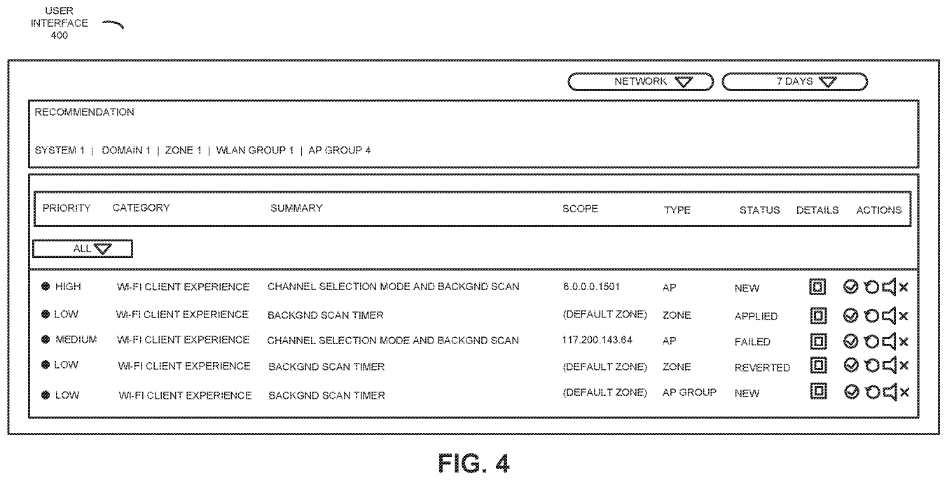

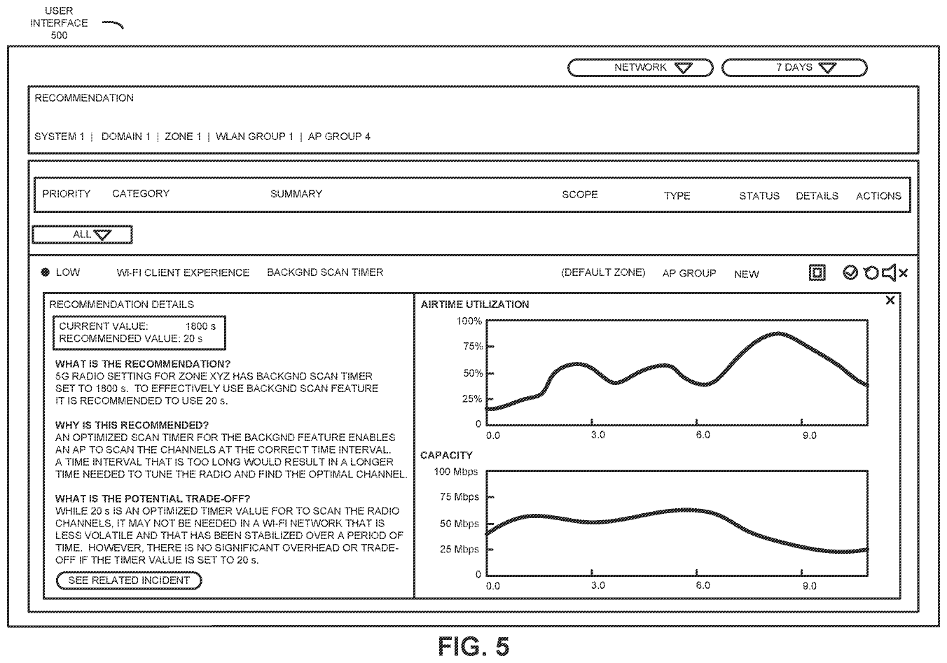

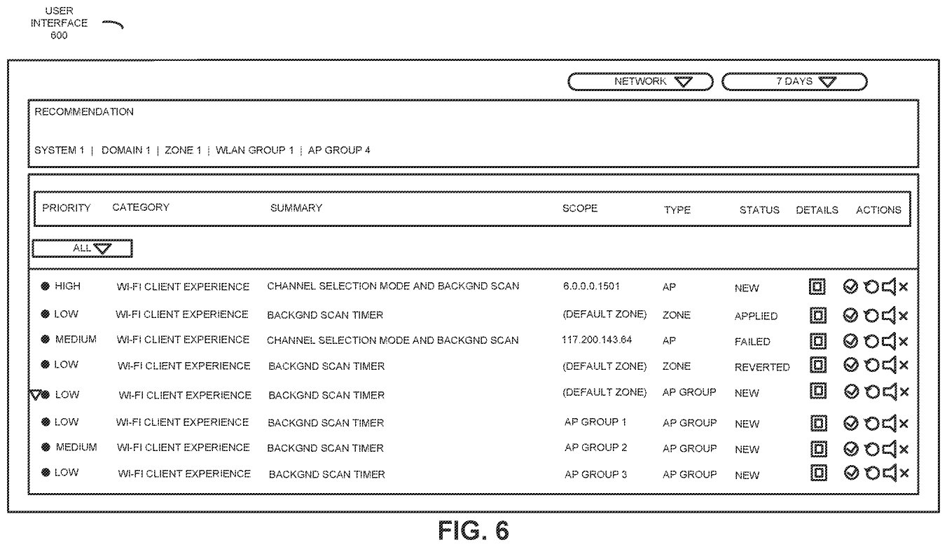

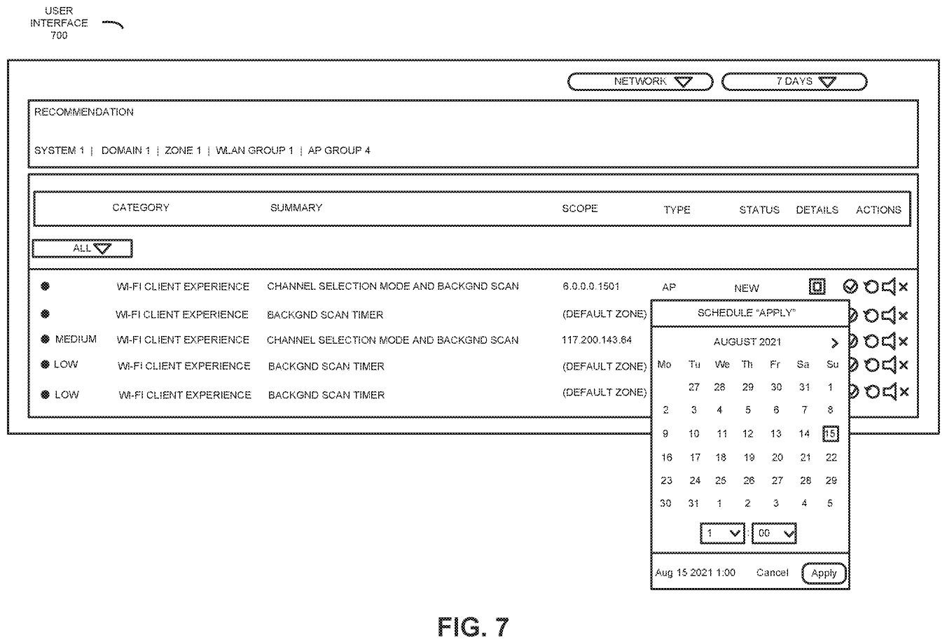

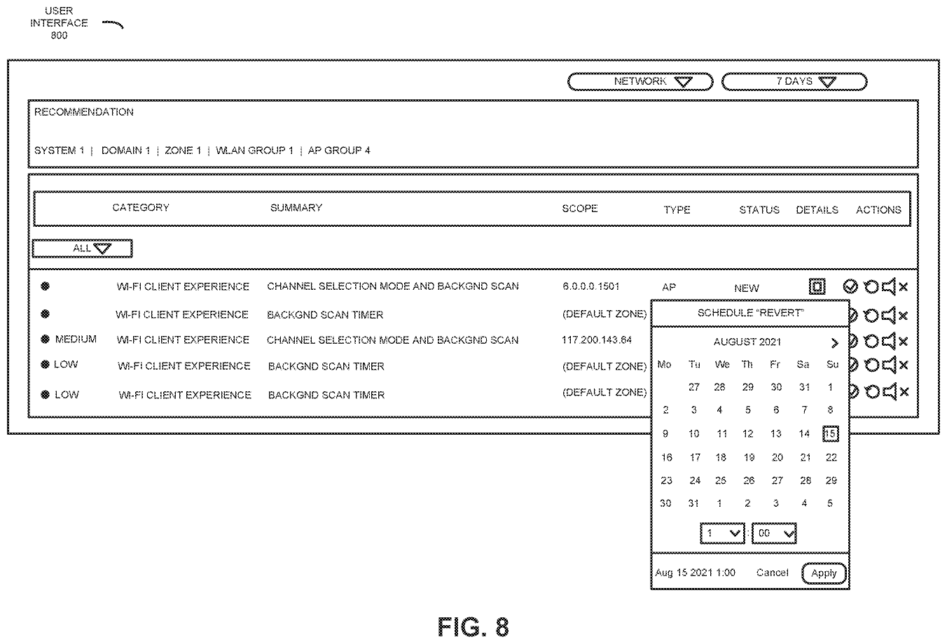

FIG. 4 presents a drawing illustrating an example of a user interface 400. This user interface may provide recommendations, which are listed with information, such as: priority, category (e.g., client experience, security, etc.), summary, scope (e.g., the name or identifier of an access point, zone, etc.), a type of the entity, status (failed, recommended, cannot be pushed to controller, e.g., because of inter-dependency, interrupted, e.g., because configuration change is no longer relevant, etc.), details (as described below with reference to FIG. 5), actions (as described below with reference to FIG. 6), schedule applied (as described below with reference to FIG. 7), and/or revert (as described below with reference to FIG. 8).

FIG. 5 presents a drawing illustrating an example of a user interface 500. This user interface may present current and recommended values, information and knowledge about the recommendation, a details icon that provides more information about the recommendation, charts or graphs of key performance indicators that were used to determine the recommendation and which provide an indication of the communication performance, and/or an optional link to a related incident (if there is one).

FIG. 6 presents a drawing illustrating an example of a user interface 600. In this user interface, similar recommendations may be grouped together for easy viewing. Moreover, in FIG. 6, the available actions for a given recommendation may include from left to right): an apply or action button that allows a network operator or administrator to click and apply the given recommendation: a revert icon that allows a network operator or administrator to click and undo an applied recommendation: and a mute or snooze icon that, when selected, temporarily hides the given recommendation.

FIG. 7 presents a drawing illustrating an example of a user interface 700. This user interface allows a network operator or administrator to optionally schedule when a recommendation is applied at a future date/time.

FIG. 8 presents a drawing illustrating an example of a user interface 800. This user interface allows a network operator or administrator to optionally schedule when a recommendation is reverted or undone at a future date/time.

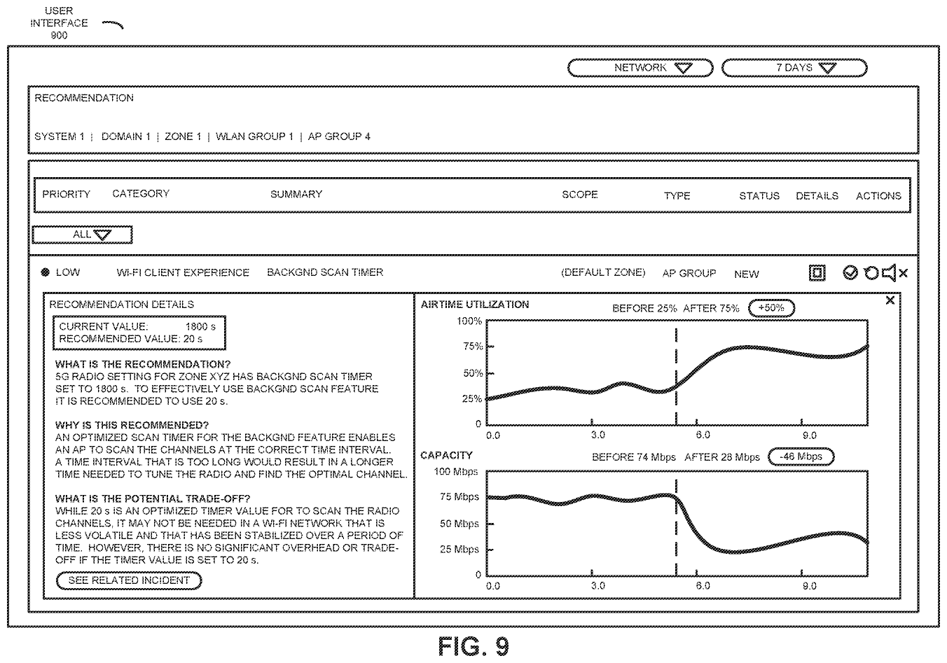

FIG. 9 presents a drawing illustrating an example of a user interface 900. This user interface presents before and after comparisons of the impact of an applied recommendation on one or more key performance indicators in the detailed information section.

In some embodiments of the monitoring techniques, the computer system may dynamically assess the impact of a recommended configuration change by computing communication-performance metrics in different time intervals on a longitudinal timeline (where a given time interval has a central location, e.g., a day, and/or a width after a timestamp of a recommended configuration change in a network). Thus, the given time interval may correspond to a time slot or a time interval (such as 24, 48 or 72 hours, or a portion of a day, a portion of a week, a portion of a month, etc.) on the longitudinal timeline. Moreover, the communication-performance metrics may be computed in time intervals before and after the recommended configuration change in order to assess the impact of the recommended configuration change. By comparing the one or more communication-performance metrics in the before and after time intervals, the computer system and/or a user may determine whether the recommended configuration changes is successful and, thus, whether it should be undone or not.

As an example of the monitoring techniques, the computer system may modify a system configuration on a specify day (e.g., Sunday) and may expect an improvement in communication-performance metrics of the network starting Monday.

In order to assess this, the computer system may compute communication-performance metrics of the network on Monday following the system configuration change and the preceding Friday. This comparison will allow the computer system to assess system-performance impact of the system configuration change.

In some embodiments, in order to have another datum for comparison, the computer system may also compare the data on Monday (after the system configuration change) with other days during the preceding week(s) (before the system configuration change). For example, the computer system may compare the data for Monday with data for the preceding Monday (so that the comparison is of two Mondays). The longitudinal time intervals may allow the computer system to determine whether to keep or undo the configuration change, and/or whether to implement another configuration change. Moreover, in some embodiments, the computer system may assess whether or not to implement a recommended configuration change, to undo a previous configuration change, and/or to implement another configuration change based on comparisons of communication performance at different levels in a hierarchy in the network, so that the impact of a given system configuration change can be assessed on different scales (such as locally or globally in the network).

In some embodiments, the communication-performance metrics may include average values of: connection success, time to connect, client throughput, access-point capacity, client receive signal strength (RSS), access point-controller connection uptime, a time to connect, authentication success, association success, extensible authentication protocol (EAP) success, radius success, dynamic host control protocol (DHCP) success, roaming success, access point-to-controller latency, access point-to-cloud based services latency, cluster latency, power-over-Ethernet (PoE) utilization, online access-point count, and/or another communication-performance metric.

Note that the preceding embodiments of the user interface may include fewer or additional objects or features, a different object or feature, a position of an object or feature may be changed, two or more objects or features may be combined into a single object or feature, and/or an object or feature may be divided into two or more objects or features.

We now describe embodiments of another method. FIG. 10 presents a flow diagram illustrating an example of a method 1000 for performing a first group of operations or a second group of operations using a computer system (such as computer system 104 in FIG. 1). During operation, the computer system may receive information (operation 1010) specifying communication in a network (such as a wired and/or a wireless network).

Then, the computer system may detect a network problem (operation 1012) based at least in part on the information. Moreover, the computer system may calculate whether a remedial action for the network problem can be determined (operation 1014).

When the remedial action can be determined (operation 1014), the computer system may automatically determine the remedial action (operation 1016) based at least in part on the detected network problem and may automatically perform the determined remedial action (operation 1018).

Alternatively, when the remedial action cannot be determined (operation 1014), the computer system may selectively instruct one or more edge electronic devices or one or more controllers in the network to collect additional information (operation 1020) for a predefined time interval. After receiving the additional information (operation 1020), the computer system may diagnose the network problem (operation 1022) and may compute a second remedial action (operation 1024) based at least in part on the diagnosis of the network problem.

Next, the computer system may provide information (operation 1026) specifying the second remedial action for approval and may receive approval (operation 1028) of the second remedial action, where, based at least in part on the received approval, the computer system may automatically perform the second remedial action when a subsequent instance of the network problem is detected. Note that the automatic remedy performed by the computer system may reduce the MTTR and, thus, may increase system availability.

In some embodiments, the computer system may optionally perform one or more additional operations. Notably, the computer system may compute communication-performance metrics for the network based at least in part on the information. Moreover, the network problem may be detected (operation 1012) based at least in part on the communication-performance metrics.

Note that the network problem may be detected (operation 1012) using a pretrained model, such as a machine-learning model or a neural network. When detecting the network problem (operation 1012), the information may be input to the pretrained model and information specifying the network problem may be output from the pretrained model. Alternatively, or additionally, the remedial action may be determined (operation 1016) using a rule engine, a look-up table or a second pretrained model, such as a machine-learning model or a neural network. When determining the remedial action (operation 1016), the information specifying the network problem may be used as an input and the remedial action may be an output from the rule engine, the look-up table or the second pretrained model.

Moreover, based at least in part on the received approval (operation 1028), the computer system may add the second remedial action to the rule engine, the look-up table or the second pretrained model.

Furthermore, when the subsequent instance of the network problem is detected, the second remedial action is automatically performed by the computer system in one or more portions of the network or one or more regions of the network associated with the network problem, such as a zone, a WLAN group, a WLAN, a group of access points, and/or an access point.

Additionally, the computer system may provide the information specifying the second remedial action for approval (operation 1026) by presenting the information specifying the second remedial action in a user interface, and the received approval (operation 1028) may correspond to user-interface activity specifying a user selection in the user interface.

Note that the remedial action or the second remedial action may include a configuration change in the network.

In some embodiments of method 1000, there may be additional or fewer operations. Furthermore, the order of the operations may be changed, and/or two or more operations may be combined into a single operation.

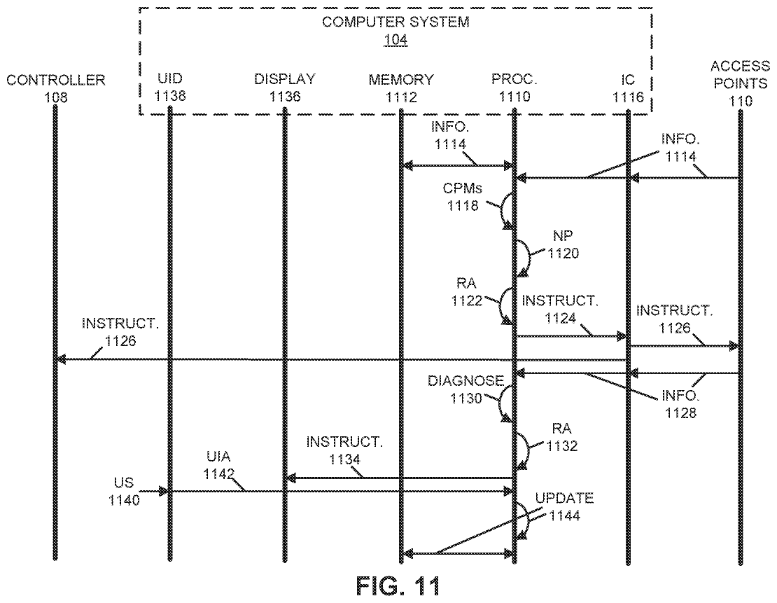

FIG. 11 presents a drawing illustrating an example of communication between components in a computer system 104. Notably, processor 1110 in computer system 104 may access information 1114 specifying communication in a network in memory 1112 in computer system 104. Alternatively, or additionally, information 1114 may be received by interface circuit (IC) 1116 in computer system 104, e.g., from access points 110. For example, information 1114 may include: real-time network data, communication-performance metrics and/or client data. Then, processor 1110 may optionally compute communication-performance metrics (CPMs) 1118 for the network based at least in part on information 1114.

Moreover, processor 1110 may automatically detect a network problem (NP) 1120 based at least in part on information 1114 and/or the communication-performance metrics 1118. Furthermore, processor 1110 may automatically determine a remedial action (RA) 1122 for the network based at least in part on the detected network problem 1120, and processor 1110 may automatically perform remedial action 1122 (e.g., by changing a configuration of the network and instructing interface circuit 1116 to communicate the change to one or more components in the network, such as to access points 110).

Alternatively, when remedial action 1122 cannot be determined or is unavailable, processor 1110 may instruct 1124 interface circuit 1116 to selectively instruct 1126 one or more edge electronic devices (such as one or more of access points 110) and/or one or more controllers in the network (such as controller 108) to collect additional information 1128 for a predefined time interval.

After receiving additional information 1128, interface circuit 1116 may provide additional information 1128 to processor 1110. Then, processor 1110 may diagnose 1130 network problem 1120 (e.g., processor 1110 may determine a root cause of network problem 1120) and may compute a remedial action 1132 based at least in part on diagnosis 1130 of network problem 1120.

Next, processor 1110 may provide information specifying remedial action 1132 for approval and receives approval of remedial action 1130. For example, processor 1110 may instruct 1134 display 1136 in computer system 104 to present remedial action 1132, e.g., in a user interface for approval by a network operator. Then, a user-interface device (UID) 1138 in computer system 104 may optionally provide, to processor 1110, user-interface activity (UIA) 1142 specifying a user selection (US) 1140 (e.g., by the network operator). For example, the network operator may approve remedial action 1130. In response to user selection 1140 specified by user-interface activity 1142, processor 1110 may update 1144, e.g., in memory 1112, a rule engine, a look-up table or a pretrained model that is used to determine a given remedial action in response to a detected network problem. Consequently, computer system 104 may automatically perform remedial action 1132 when a subsequent instance of network problem 1120 is detected.

While FIG. 11 illustrates communication between components using unidirectional or bidirectional communication with lines having single arrows or double arrows, in general the communication in a given operation in FIG. 11 may involve unidirectional or bidirectional communication.

We now further describe the monitoring techniques. A typical question from customers is what is wrong with my network? Many customers desire less or no involvement in the root cause analysis process. Their expectation is no downtime and no human or resource costs for troubleshooting and fixing network problems. Analytical tools and services often provide a lot of information to a user, such as insights and incidents, but the onus is on the customer to understand, diagnose, troubleshoot and/or correct network problems. In principle, time saved in troubleshooting corresponds to increased revenue. Furthermore, often minimal or seemingly minor corrections to a network in real-time can prevent network problems from occurring.

However, continuous monitoring of a network by customers is typically expensive, and it may be difficult to apply corrects as feedback. Notably, analytical tools and services collect data and convert it into analytics, but because of the lack of feedback capability edge corrections typically cannot be made.

In the disclosed monitoring technique, one or more predictive models (such as a machine-learning model or a neural network) are used to detect, correct and/or provide avoidance techniques to avoid the aforementioned problems in wireless and/or wired networks. Notably, an analytics system with edge feedback may collect initial data and detect network problems (which may include opportunity costs and/or power consumption by a network). When a network problem is detected, a pretrained model (such as a machine-learning model or a neural network) in this closed-cycle analytics system may automatically perform a suitable predefined (and pre-approved) remedial action. Alternatively, the analytics system may selectively instruct one or more edge electronic devices or controllers to temporarily collect additional information to diagnose the network problem. This additional information and the diagnosed network problem may be used to compute a second remedial action. The second remedial action may be presented to a network operator or administrator in order to obtain advanced approval for automatic performance of the second remedial action when a subsequent instance of the network problem is detected.

Artificial intelligence/machine learning-based insights may be implemented using analytical services and tools in a network. These capabilities may allow users to get the details about anomalies in their deployed network. In general, the insights that are based on statistics and events may be very useful. However, in the current approach, it typically not possible to determine the root cause of a fault or an incident that impacted the network. Notably, data from end-point electronic device(s) usually do not provide extensive details, logs are often at the information level instead of the detailed-debug level, and there is typically limited or no detailed data about internal processes (such as advanced debug logs) that were invoked when issue occurred.

Moreover, even in cases where a network problem is known, the absence of a feedback system in current network architecture/design makes it difficult to act or take corrective action when a fault or an incident occurs, because there is usually no way to automatically correct or avoid the network problem. Consequently, while a network operator or administrator is provided high-level information about a network problem, additional debugging is often needed to pin-point the issue and determine the root cause (which is sometimes referred to as ‘diagnosing’).

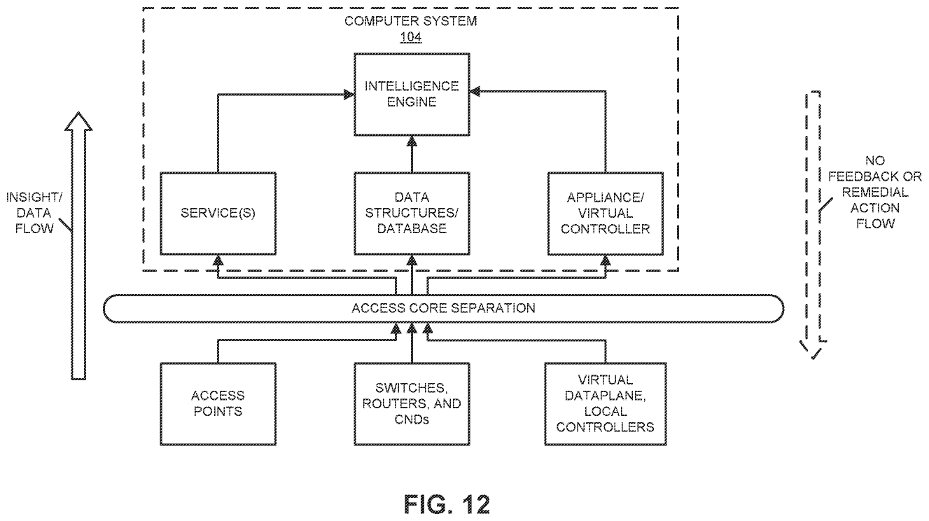

FIG. 12 presents a drawing illustrating an example of communication between components in computer system 104 (FIG. 1). Notably, cloud-based analytical services and tools may only receive statistics and counts from electronic devices in the network. The cloud-based analytical services and tools may not receive detailed logs from these electronic devices. Moreover, while the electronic devices may be controlled by components in the network, in FIG. 12 there is no dynamic event-driven data collection and feedback or action flow to allow remedial action to be taken by the endpoint or edge electronic devices (such as access points or switches).

However, there are many scenarios where corrective or avoidance actions taken on electronic devices in a network (such as on access points, switches, routers, controllers and/or data planes) may overcome a fault and/or may prevent a subsequent instance of the fault. Notably, intelligence may be provided using artificial intelligence/machine-learning techniques to aid these electronic devices (e.g., via secure messaging) to mitigate or overcome a network problem and/or to make sure that the network problem does not reoccur. For example, corrections for detected incidents or anomalies and/or mitigation or avoidance of future incidents or anomalies may be implemented by sending feedback or a remedial action to particular electronic devices. The artificial intelligence/machine-learning feedback and/or corrective system may significantly improve a mean time to repair (MTTR). These capabilities may improve the user experience, which may be important for market segments such as hospitality, restaurants, etc.

In the disclosed monitoring techniques, a computer system may exploit the locality of an anomaly (such as a difference from normal or historical network performance or behavior, and which is sometimes referred to as a ‘network problem’) in which the odds pr probability of the same issue recurring at this location are high. By collecting an expanded level of statistics and detailed logs during such a time frame, it may be easier for the computer system to more accurately perform root cause analysis. Moreover, most of the tasks in the monitoring or collecting of the additional data can be automated so that customer involvement is minimal or is eliminated. Note that the monitoring or the collection of the additional data may be implemented using software and/or hardware agents on electronic devices (such as access points, switches or virtual data planes) and in local and/or could-based analysis services and tools (which may be performed by a computer system). The intelligence derived by this analysis may aid in or facilitate root-cause analysis or diagnosis of network problems, corrective or remedial actions and in deploying issue avoidance techniques in the network elements or components.

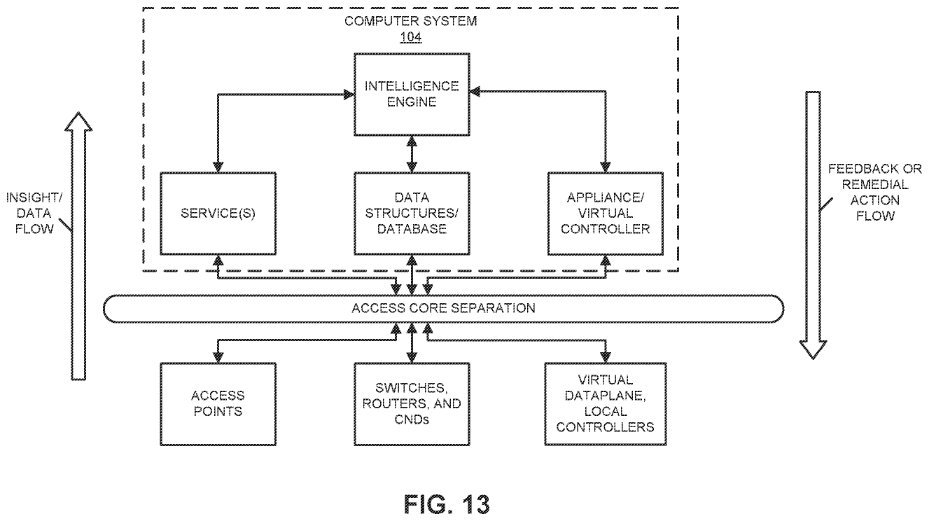

These capabilities are shown in FIG. 13, which presents a drawing illustrating an example of communication between components in computer system 104 (FIG. 1). In FIG. 13, an intelligence engine (which may be implemented using artificial intelligence and/or machine learning) in computer system 104 may selectively invoke dynamic collection of additional (detailed) data when certain network problems occur, and may take corrective and/or avoidance actions based at least in part on the additional data.

Notably, the intelligence engine may use artificial intelligence and/or machine learning to collect distributed data from the intermediate or edge electronic devices. This intelligence engine may be centralized or distributed and may be implemented in a local computer system and/or a cloud-based computer system. Using the data from edge electronic devices, the intelligence engine may confirm or detect an anomaly. Then, the intelligence engine may enable electronic devices in specific functional area(s) or region(s) by sending control and management triggers that will instantiate or activate agents in these electronic devices to collect the additional (detailed) data.

In some embodiments, the intelligence engine may use a rule engine to perform at least some of the operations in the communication techniques. For example, when an access point is using 70% of available memory, the remedial action in the rule engine may include an instruction to cease providing probe response and/or to perform load balancing. The rule engine may be built over time depending on the data received. A given rule may be a mapping from a set of one or more incidents or one or more conditions to corresponding remedial actions that should be taken when the set of one or more incidents or one or more conditions occur. These rules may be populated by a user of computer system 104, e.g., via a user interface or an application programming interface. Alternatively, or additionally, the rules may be dynamically created when the intelligence engine determines a set of one or more incidents or one or more conditions and a remedial action are co-related. These co-relations may also occur across or between different rules.

When a new rule is created, it may be presented to a user to get confirmation or approval to apply this rule when the corresponding incident(s) or condition(s) occur. This approval process may be implemented using a user interface, an application programming interface and/or a command line interface. After the user approves the new rule, the rule engine may be updated and the intelligence engine may start monitoring data and selectively applying the new rule.

Note that the intelligence engine may continuously receive insights, such as statistics and counters. These insights may indicate the states of edge electronic devices (such as access points and switches), a controller of a data plane (such as a virtual controller and/or a virtual data plane) and/or end-user electronic devices (such as cellular telephones, laptops, tablets, etc.).

When an anomaly is detected based at least in part on the insights, the intelligence engine may send a trigger to an agent to enable collection of detailed operating statistics (such as connections, disconnections, etc.) and data for a specified time duration. A control agent in computer system 104 (e.g., in a services module) may translate this to message into instructions that the edge electronic devices can understand. Moreover, in the identified functional area of anomaly, the agent on an electronic device may map the anomaly to corresponding functional area(s) and/or program instructions (or program modules) that are responsible for related functions executed by the electronic device. Note that the electronic-device agent may perform the following operations: map anomaly functional areas to program instructions: for each of the identified program instructions and related process(es), raise/reduce the debug level logging: for the identified program instructions, enable tracing of code and functional flow: collect detailed statistics (e.g., counters that are generated internally but that are usually not exposed): and/or provide detailed logs. For example, when an authentication failure occurs on an access point, additional data may be collected for different functional areas, including: a host, IEEE 802.11 debug, a dynamical host control protocol (DHCP) server, etc.

The duration of the additional data collection may be predefined, predetermined and/or dynamically decided on the case-by-case basis. The electronic-device agent may collect the logs and statistics, and may parse the additional information for symptoms (e.g., of the network problem). Moreover, the electronic-device agent may compress the additional data or information in a message or a file and may sent the message or the file to the intelligence agent during the time duration (e.g., continuously or live streaming, periodically or as needed) or after the time duration has expired. In some embodiments, the electronic-device agent. When the intelligence agent determines that sufficient additional data has been received, the intelligence agent may provide a trigger message to the electronic-device agent to stop streaming the additional data. Note that communication of live-streamed data or discrete data files may be used depending on the use cases or the nature of the network problem.

After the additional detailed data is received by the intelligence engine, the intelligence engine may apply a pretrained model (such as a machine-learning model or a neural network) and procedures to the additional data to determine the root cause of the anomaly or network problem (or to diagnose the network problem). Then, the intelligence engine may match a rule in the rule engine to the diagnosed network problem to obtain a corresponding remedial action. This remedial action may be triggered by the intelligence engine and controllers in the network may instruct edge electronic devices to take action at the edge of the network based at least in part on the remedial action.

When a remedial action is executed by an edge electronic device, an agent in this edge electronic device may send a confirmation and status back to the controller, and the controller may relay this information to the intelligence engine. The intelligence engine may record this incident and the action taken, and may present a summary to a user via a user interface, an application programming interface or a command line interface.

In some embodiment, when there is no corresponding rule in the rule engine for a particular diagnosed network problem, the intelligence engine may generate a new rule and may update the rule engine (e.g., after the new rule is approved by the user).

Note that the corrective or avoidance actions after diagnosis of the network problem may include: notifying an administrator or network operator to manually take corrective or remedial action: performing a predefined and pre-approved remedial action in the rule engine (or a database or data structure of corrective actions) by sending a trigger to one or more of the edge electronic devices for corrective actions or avoidance of the issue: after the remedial action is performed, providing an acknowledgement report or summary with the results of the remedial action; selectively update the remedial action for use when a subsequent instance of the network problem (or a similar network problem) is detected: and/or generate a new remedial action to address the network problem (or a similar network problem).

We now describe embodiments of a third method. FIG. 14 presents a flow diagram illustrating an example of a method 1400 for dynamically assessing an impact of a configuration change on a network using a computer system (such as computer system 104 or a controller 108 in FIG. 1). During operation, the computer system may receive information (operation 1410) specifying a configuration change in a network (such as a wired and/or a wireless network).

In response, the computer system may dynamically compute a change in one or more communication-performance metrics (operation 1412) based at least in part on time intervals before and after the configuration change. For example, the one or more communication-performance metrics may include communication-performance metrics associated with: connections in the network, infrastructure associated with the network (such as one or more controllers), and electronic devices in the network.

Moreover, the computer system may provide a summary (operation 1414) of the one or more communication-performance metrics. Note that providing the summary may include presenting the summary in a table in a user interface.

In some embodiments, the computer system may optionally perform one or more additional operations (operation 1416). Notably, the computer system may receive information specifying the time intervals. For example, the computer system may receive user-interface activity associated with a user (such as an operator of the network) that specifies the time intervals. The user-interface activity may be associated with a calendar or a longitudinal timeline. In some embodiments, the user-interface activity may specify dynamic selection of configurable time intervals on the longitudinal timeline.

Alternatively, the computer system may automatically calculate or select the time intervals based at least in part on a type of the configuration change or a timestamp of the configuration change.

Furthermore, the configuration change may be included in a set of configuration changes that are arranged or filtered based at least in part on a hierarchy of electronic devices in the network. For example, the network may be a WLAN that is compatible with an IEEE 802.11 standard, and the hierarchy may include: a zone, a WLAN group, a WLAN, a group of access points, an access point, and an access-point firmware update.

In some embodiments, the computer system may automatically detect a communication-performance degradation associated with the configuration change, and may perform a remedial action. For example, the remedial action may include providing a recommended remedial action (such as a second configuration change) for approval by the operator of the network. Alternatively or additionally, the computer system may calculate a predicted communication-performance improvement associated with the configuration change, and the computer system may recommend the configuration change.

In some embodiments of method 1400, there may be additional or fewer operations. Furthermore, the order of the operations may be changed, and/or two or more operations may be combined into a single operation.

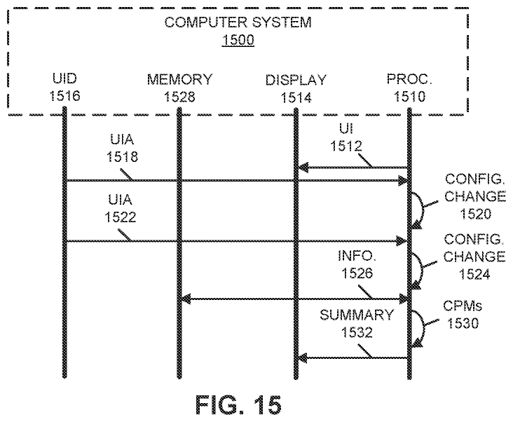

FIG. 15 presents a drawing illustrating an example of communication between components in a computer system 1500. Notably, processor 1510 may instruct display 1514 to display a user interface (UI) 1512. This user interface may indicate or specify a configuration change in a list of configuration changes in a network.

Then, a user may specify or select a configuration change 1520 in the list. For example, display 1514 may be a touch-sensitive display, and user-interface activity may specify selection of the configuration change. More generally, user-interface activity (UIA) 1518 of the user with a user-interface device (UID) 1516 may specify configuration change 1520. Notably, user-interface device 1516 may provide user-interface activity 1518 of the user to processor 1510, which may determine configuration change 1520 from user-interface activity 1518.

Moreover, user-interface activity 1522 of the user with user-interface device 1516 may specify time intervals 1524 before and after configuration change 1520. Notably, user-interface device 1516 may provide user-interface activity 1522 to processor 1510, which may determine time intervals 1524 from user-interface activity 1522.

Next, processor 1510 may dynamically compute a change in one or more communication-performance metrics (CPMs) 1528 based at least in part on time intervals 1524. For example, processor 1510 may compute the difference in the one or more communication-performance metrics 1530 between a time interval after configuration change 1520 and a time interval before configuration change 1520. Note that computing the difference in the one or more communication-performance metrics 1530 may involve processor 1510 accessing stored information 1526 in memory 1528.

Furthermore, processor 1510 may instruct display 1514 to display a summary 1532 of the one or more communication-performance metrics 1530 in user interface 1512. For example, summary 1532 may be included in a table in user interface 1512.

While FIG. 15 illustrates communication between components using unidirectional or bidirectional communication with lines having single arrows or double arrows, in general the communication in a given operation in these figures may involve unidirectional or bidirectional communication.

We now further describe the monitoring techniques. In some embodiments of the monitoring techniques a user may dynamically assess the impact of a configuration change by interacting with a graphical user interface that include a visual time-series graph or longitudinal timeline (which is sometimes referred to as a ‘lens user interface’). The graphical user interface may include two or more visual scroll widgets (which are sometimes referred to as ‘lenses’). These visual scroll widgets are movable or scrollable, so that the user may interact with a given visual scroll widget to specify either or both time intervals (such as a central location, e.g., a day, and/or a width) before and after a timestamp of a configuration change in a network. Thus, a given lens may correspond to a time slot or a time interval (such as 24, 48 or 72 hours, or a portion of a day, a portion of a week, a portion of a month, etc.) on the longitudinal timeline, and there may be a ‘before’ lens and an ‘after’ lens relative to the timestamp of the configuration change. Based at least in part on the user selection of the configuration change and specifying or defining the time intervals using the lenses, the computer system may dynamically compute one or more communication-performance metrics (which are sometimes referred to as key performance indicators or KPIs) or other data. This comparison may compare the one or more communication-performance metrics in the before and after time intervals in order to help the user assess and visualize the change in performance associated with the configuration change.

Consequently, the monitoring techniques may allow a user to use a graphical user interface to interactively and holistically assess before and after summary information of the impact of a configuration change. In some embodiments, for ease of visualization, the graphical user interface may color code different configuration changes on the longitudinal timeline and/or to view the one or more communication-performance metrics associated with configuration changes associated with electronic devices (which are sometimes referred to as ‘entities’) in different levels in a hierarchy in the network. Note that a given entity (which may correspond to configuration changes associated with one or more electronic devices) may be represented by a row of colored dots in the longitudinal timeline.

As an example of the monitoring techniques, a wired and/or wireless network administrator (or operator) may modify a system configuration on a specify day (e.g., Sunday) and may expect an improvement in communication-performance metrics of the network starting Monday.

In order to verify this, the network administrator may use the graphical user interface to view and assess communication-performance metrics of the network on Monday following the system configuration change and the preceding Friday. This comparison will allow the network administrator to assess system-performance impact of the system configuration change.

In some embodiments, in order to have another datum for comparison, the network administrator may also compare the data on Monday (after the system configuration change) with other days during the preceding week(s) (before the system configuration change). For example, the network administrator may compare the data for Monday with data for the preceding Monday (so that the comparison is of two Mondays). The lenses in the graphical user interface may allow the network administrator to visually view this information by scrolling the two scrolling the before and after widgets on the time-series graph. Moreover, the computer system may perform a dynamic comparison of the data in these two time intervals and to present the comparison in the graphical user interface (such as in a table or summary). Furthermore, the graphical user interface may allow the network administrator to select system configuration changes associated with electronic devices at different levels in a hierarchy in the network, so that the impact of a given system configuration change can be assessed on different scales (such as locally or globally in the network). Thus, the graphical user interface may allow the network administrator to select system configuration changes at different levels in the hierarchy in the network.

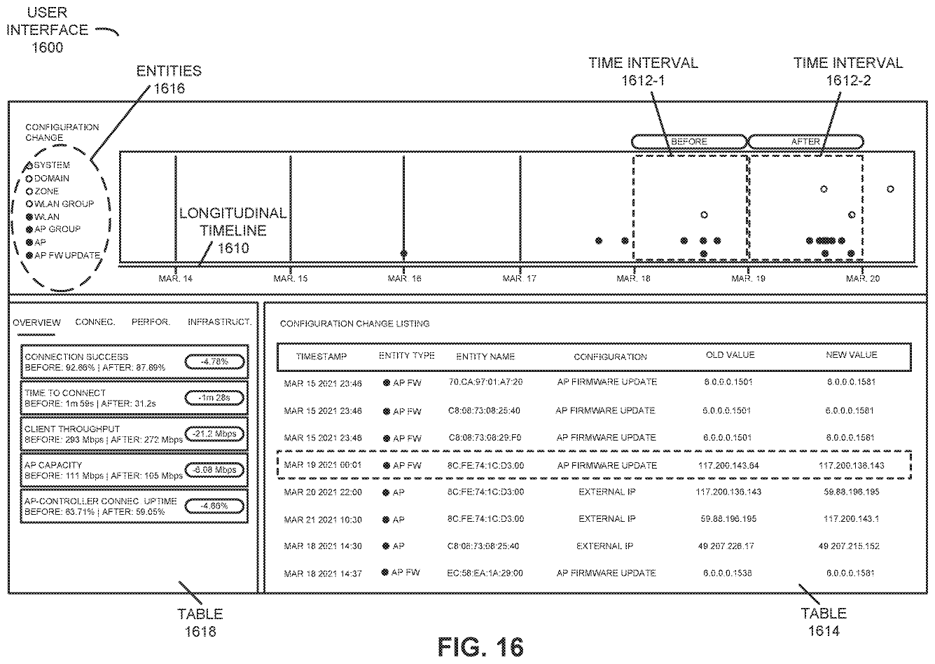

FIG. 16 presents a drawing illustrating an example of a user interface 1600 in accordance with an embodiment of the present disclosure. This user interface may include a longitudinal timeline 1610, configurable time intervals 1612, a set of configuration changes in table 1614, entities 1616 at different levels in a hierarchy in the network, and/or a table 1618 with one or more differences or changes in aggregate communication-performance metrics in the network between time intervals 1612. The user of user interface 1600 may select one of the configuration changes in table 1614 (which is associated with a given entity in entities 1616) and/or may specify or configure time intervals 1612 (such as a center and/or a width of a given time interval). In response, a computer system may dynamically compute the differences or changes in communication-performance metrics between time intervals 1612 and may update table 1618. Note that the different entities 1616 (i.e., the levels or layers in the hierarchy) may include: a zone, a WLAN group (of one or more WLANs), a WLAN, an access-point group (of one or more access points), one or more access points, and/or an access-point firmware (FW) update. In some embodiments, the set of configuration changes in table 1614 may be arranged or organized according to the configuration changes that had the biggest impact on the aggregate communication-performance metrics.

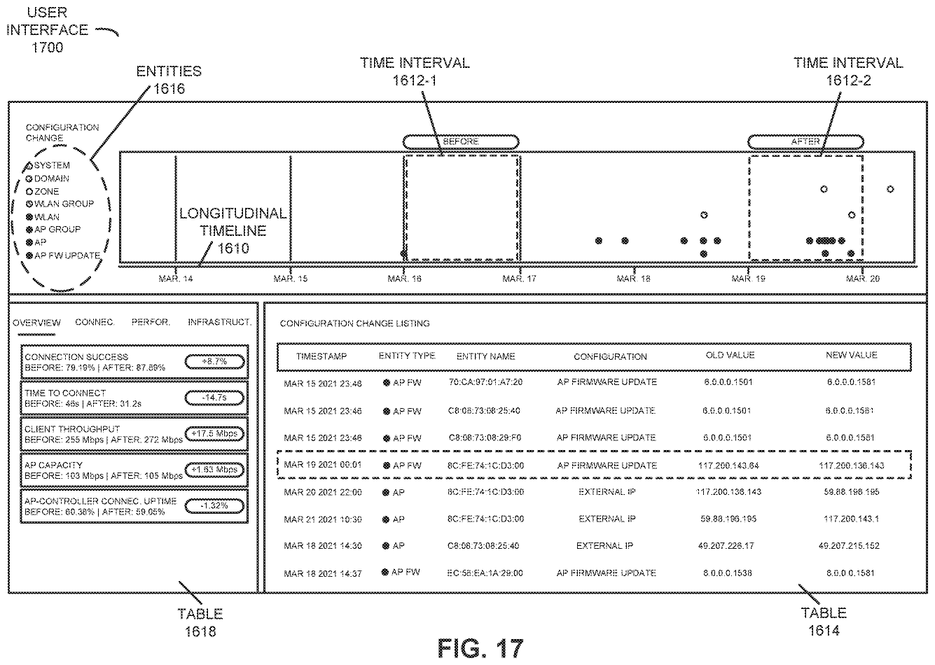

Moreover, as shown in FIG. 17, which presents a drawing illustrating an example of a user interface 1700 in accordance with an embodiment of the present disclosure, the user may modify either or both of time intervals 1612 (such as by sliding time interval 1612-1 to a different day). In response, the computer system may dynamically compute the differences or changes in communication-performance metrics between time intervals 1612 and may update table 1618.

Furthermore, as shown in FIGS. 16-20, which presents a drawing illustrating examples of user interface 1700 in accordance with an embodiment of the present disclosure, the user may select different groups of communication-performance metrics for display in table 1618. Thus, in some embodiments, the one or more communication-performance metrics may include average values of: connection success, time to connect, client throughput, access-point capacity, client receive signal strength (RSS), access point-controller connection uptime, a time to connect, authentication success, association success, extensible authentication protocol (EAP) success, radius success, dynamic host control protocol (DHCP) success, roaming success, access point-to-controller latency, access point-to-cloud based services latency, cluster latency, power-over-Ethernet (POE) utilization, online access-point count, and/or another communication-performance metric.

Note that the preceding embodiments of the user interface may include fewer or additional objects or features, a different object or feature, a position of an object or feature may be changed, two or more objects or features may be combined into a single object or feature, and/or an object or feature may be divided into two or more objects or features.

We now describe embodiments of an electronic device, which may perform at least some of the operations in the monitoring techniques. FIG. 21 presents a block diagram illustrating an example of an electronic device 2100 in accordance with some embodiments, such as one of: a computer in computer system 104, one of computer network devices 106, controller 108, one of access points 110 or one of electronic devices 112. This electronic device includes processing subsystem 2110, memory subsystem 2112, and networking subsystem 2114. Processing subsystem 2110 includes one or more devices configured to perform computational operations. For example, processing subsystem 2110 can include one or more microprocessors, ASICs, microcontrollers, programmable-logic devices, one or more graphics process units (GPUs) and/or one or more digital signal processors (DSPs).

Memory subsystem 2112 includes one or more devices for storing data and/or instructions for processing subsystem 2110 and networking subsystem 2114. For example, memory subsystem 2112 can include dynamic random access memory (DRAM), static random access memory (SRAM), and/or other types of memory. In some embodiments, instructions for processing subsystem 2110 in memory subsystem 2112 include: one or more program modules or sets of instructions (such as program instructions 2122 or operating system 2124), which may be executed by processing subsystem 2110. Note that the one or more computer programs may constitute a computer-program mechanism. Moreover, instructions in the various modules in memory subsystem 2112 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 2110.

In addition, memory subsystem 2112 can include mechanisms for controlling access to the memory. In some embodiments, memory subsystem 2112 includes a memory hierarchy that comprises one or more caches coupled to a memory in electronic device 2100. In some of these embodiments, one or more of the caches is located in processing subsystem 2110.

In some embodiments, memory subsystem 2112 is coupled to one or more high-capacity mass-storage devices (not shown). For example, memory subsystem 2112 can be coupled to a magnetic or optical drive, a solid-state drive, or another type of mass-storage device. In these embodiments, memory subsystem 2112 can be used by electronic device 2100 as fast-access storage for often-used data, while the mass-storage device is used to store less frequently used data.

Networking subsystem 2114 includes one or more devices configured to couple to and communicate on a wired and/or wireless network (i.e., to perform network operations), including: control logic 2116, an interface circuit 2118 and one or more antennas 2120 (or antenna elements). (While FIG. 21 includes one or more antennas 2120, in some embodiments electronic device 2100 includes one or more nodes, such as nodes 2108, e.g., a network node that can be coupled or connected to a network or link, or an antenna node, connector or a metal pad that can be coupled to the one or more antennas 2120. Thus, electronic device 2100 may or may not include the one or more antennas 2120.) For example, networking subsystem 2114 can include a Bluetooth™ networking system, a BLE networking system, a Zigbee networking system, a Loran network system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Note that a transmit or receive antenna pattern (or antenna radiation pattern) of electronic device 2100 may be adapted or changed using pattern shapers (such as reflectors) in one or more antennas 2120 (or antenna elements), which can be independently and selectively electrically coupled to ground to steer the transmit antenna pattern in different directions. Thus, if one or more antennas 2120 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 2100 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 2114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2100 may use the mechanisms in networking subsystem 2114 for performing simple wireless communication between the electronic devices, e.g., transmitting advertising or beacon frames and/or scanning for advertising frames transmitted by other electronic devices as described previously.

Within electronic device 2100, processing subsystem 2110, memory subsystem 2112, and networking subsystem 2114 are coupled together using bus 2128. Bus 2128 may include an electrical, optical, and/or electro-optical connection that the subsystems can use to communicate commands and data among one another. Although only one bus 2128 is shown for clarity, different embodiments can include a different number or configuration of electrical, optical, and/or electro-optical connections among the subsystems.

In some embodiments, electronic device 2100 includes a display subsystem 2126 for displaying information on a display, which may include a display driver and the display, such as a liquid-crystal display, a multi-touch touchscreen, etc.

Electronic device 2100 can be (or can be included in) any electronic device with at least one network interface. For example, electronic device 2100 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of multiple computer network devices, a controller, test equipment, an IoT device, and/or another electronic device.

Although specific components are used to describe electronic device 2100, in alternative embodiments, different components and/or subsystems may be present in electronic device 2100. For example, electronic device 2100 may include one or more additional processing subsystems, memory subsystems, networking subsystems, and/or display subsystems. Additionally, one or more of the subsystems may not be present in electronic device 2100. Moreover, in some embodiments, electronic device 2100 may include one or more additional subsystems that are not shown in FIG. 21. Also, although separate subsystems are shown in FIG. 21, in some embodiments some or all of a given subsystem or component can be integrated into one or more of the other subsystems or component(s) in electronic device 2100. For example, in some embodiments program instructions 2122 are included in operating system 2124 and/or control logic 2116 is included in interface circuit 2118.

Moreover, the circuits and components in electronic device 2100 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of electronic device 2100 and/or networking subsystem 2114. The integrated circuit may include hardware and/or software mechanisms that are used for transmitting wireless signals from electronic device 2100 and receiving signals at electronic device 2100 from other electronic devices. Aside from the mechanisms herein described, radios are generally known in the art and hence are not described in detail. In general, networking subsystem 2114 and/or the integrated circuit can include any number of radios. Note that the radios in multiple-radio embodiments function in a similar way to the described single-radio embodiments.

In some embodiments, networking subsystem 2114 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit.

Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wired and/or wireless communication techniques may be used. Thus, the monitoring techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the monitoring techniques may be implemented using program instructions 2122, operating system 2124 (such as a driver for interface circuit 2118) or in firmware in interface circuit 2118. Alternatively or additionally, at least some of the operations in the monitoring techniques may be implemented in a physical layer, such as hardware in interface circuit 2118.

Note that the use of the phrases ‘capable of,’ ‘capable to,’ ‘operable to, or ‘configured to’ in one or more embodiments, refers to some apparatus, logic, hardware, and/or element designed in such a way to enable use of the apparatus, logic, hardware, and/or element in a specified manner.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the monitoring techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer system, comprising:
an interface circuit;
a memory configured to store program instructions; and
a processor coupled to the interface circuit and the memory, wherein the processor is configured to execute the program instructions, and wherein, when executed by the processor, the program instructions cause the computer system to perform operations comprising:
receiving information specifying communication in a network;
detecting a network problem based at least in part on the information; and
performing a first group of operations or a second group of operations, wherein the first group of operations comprises automatically determining a remedial action based at least in part on the detected network problem; and
automatically performing the determined remedial action; and
wherein the second group of operations comprises:
when the remedial action cannot be determined, selectively instructing one or more edge electronic devices or one or more controllers in the network to collect additional information for a predefined time interval;
after receiving the additional information, diagnosing the network problem;
computing a second remedial action based at least in part on the diagnosis of the network problem;
providing information specifying the second remedial action for approval; and
receiving approval of the second remedial action, wherein, based at least in part on the received approval, the computer system is configured to automatically perform the second remedial action when a subsequent instance of the network problem is detected.

2. The computer system of claim 1, wherein the operations comprise computing communication-performance metrics for the network based at least in part on the information; and
wherein the network problem is detected based at least in part on the communication-performance metrics.

3. The computer system of claim 1, wherein the network problem is detected using a pretrained model; and
wherein, when detecting the network problem, the information is input to the pretrained model and information specifying the network problem is output from the pretrained model.

4. The computer system of claim 3, wherein the pretrained model comprises a machine-learning model or a neural network.

5. The computer system of claim 1, wherein the remedial action is determined using a rule engine, a look-up table or a second pretrained model; and
wherein, when determining the remedial action, the information specifying the network problem is used as an input to the rule engine, the look-up table or the second pretrained model and the remedial action is an output from the rule engine, the look-up table or the second pretrained model.

6. The computer system of claim 5, wherein the second pretrained model comprises a machine-learning model or a neural network.

7. The computer system of claim 5, wherein the operations comprise, based at least in part on the received approval, adding the second remedial action to the rule engine, the look-up table or the second pretrained model.

8. The computer system of claim 1, wherein, when the subsequent instance of the network problem is detected, the computer system is configured to automatically perform the second remedial action in one or more portions of the network, or one or more regions of the network associated with the network problem.

9. The computer system of claim 8, wherein the one or more portions of the network or the one or more regions of the network comprise: a zone, a wireless local area network (WLAN) group, a WLAN, a group of access points, and/or an access point.

10. The computer system of claim 1, wherein providing the information specifying the second remedial action for approval comprises presenting the information specifying the second remedial action in a user interface, and the received approval corresponds to user-interface activity specifying a user selection in the user interface.

11. The computer system of claim 1, wherein the remedial action or the second remedial action comprises a configuration change in the network.

12. A non-transitory computer-readable storage medium for use in conjunction with a computer system, the computer-readable storage medium storing program instructions, wherein, when executed by the computer system, the program instructions cause the computer system to perform operations comprising:
receiving information specifying communication in a network;
detecting a network problem based at least in part on the information; and
performing a first group of operations or a second group of operations;
wherein the first group of operations comprises automatically determining a remedial action based at least in part on the detected network problem; and
wherein the second group of operations comprises:
when the remedial action cannot be determined, selectively instructing one or more edge electronic devices or one or more controllers in the network to collect additional information for a predefined time interval;
after receiving the additional information, diagnosing the network problem;
computing a second remedial action based at least in part on the diagnosis of the network problem;
providing information specifying the second remedial action for approval; and
receiving approval of the second remedial action, wherein, based at least in part on the received approval, the operations comprise automatically performing the second remedial action when a subsequent instance of the network problem is detected.

13. The non-transitory computer-readable storage medium of claim 12, wherein the network problem is detected using a pretrained model; and
wherein, when detecting the network problem, the information is input to the pretrained model and information specifying the network problem is output from the pretrained model.

14. The non-transitory computer-readable storage medium of claim 12, wherein the remedial action is determined using a rule engine, a look-up table or a second pretrained model; and
wherein, when determining the remedial action, the information specifying the network problem is used as an input to the rule engine, the look-up table or the second pretrained model and the remedial action is an output from the rule engine, the look-up table or the second pretrained model.

15. The non-transitory computer-readable storage medium of claim 14, wherein the operations comprise, based at least in part on the received approval, adding the second remedial action to the rule engine, the look-up table or the second pretrained model.

16. A method for performing a first group of operations or a second group of operations, comprising:
by a computer system:
receiving information specifying communication in a network;
detecting a network problem based at least in part on the information; and
performing the first group of operations or the second group of operations;
wherein the first group of operations comprises automatically determining a remedial action based at least in part on the detected network problem; and
wherein the second group of operations comprises:
when the remedial action cannot be determined, selectively instructing one or more edge electronic devices or one or more controllers in the network to collect additional information for a predefined time interval;
after receiving the additional information, diagnosing the network problem;
computing a second remedial action based at least in part on the diagnosis of the network problem;
providing information specifying the second remedial action for approval; and
receiving approval of the second remedial action, wherein, based at least in part on the received approval, the method comprises automatically performing the second remedial action when a subsequent instance of the network problem is detected.

17. The method of claim 16, wherein the network problem is detected using a pretrained model; and
wherein, when detecting the network problem, the information is input to the pretrained model and information specifying the network problem is output from the pretrained model.

18. The method of claim 16, wherein the remedial action is determined using a rule engine, a look-up table or a second pretrained model; and
wherein, when determining the remedial action, the information specifying the network problem is used as an input to the rule engine, the look-up table or the second pretrained model and the remedial action is an output from the rule engine, the look-up table or the second pretrained model.

19. The method of claim 18, wherein the operations comprise, based at least in part on the received approval, adding the second remedial action to the rule engine, the look-up table or the second pretrained model.

20. The method of claim 16, wherein providing the information specifying the second remedial action for approval comprises presenting the information specifying the second remedial action in a user interface, and the received approval corresponds to user-interface activity specifying a user selection in the user interface.
